(19) United States
(12) Patent Application Publication
(10) Pub. No.: US 2015/0059580 A1
(43) Pub. Date: Mar. 5, 2015

(54) FORENSIC AIR AND SURFACE SAMPLER TECHNOLOGY (FASST) COLLECTOR

(71) Applicant: MRIGlobal, Kansas City, MO (US)

(72) Inventors: Joseph W. Clement, Kansas City, MO (US); Peter J. Anderson, Lawrence, KS (US); Micah R. Decker, Kansas City, MO (US); Thomas J. Keeley, Kansas City, MO (US); Mary E. Pierce, Grain Valley, MO (US); Valorie T. Ryan, Merritt Island, FL (US); Darren J. Radke, Overland Park, KS (US)

(21) Appl. No.: 14/121,380

(22) Filed: Aug. 26, 2014

Related U.S. Application Data
(60) Provisional application No. 61/870,544, filed on Aug. 27, 2013.

(51) Int. Cl. B03C 3/68; B03C 3/38

(52) U.S. Cl. CPC B03C 3/68; B03C 3/38
USPC 96/18; 96/96; 96/23; 96/19; 96/55; 96/26; 96/60; 96/80

(57) ABSTRACT

A particle collector for collecting biological material using electrostatic precipitator (ESP) technology including a removable ESP collection tube having an electrode wire suspended therein, a high voltage power supply coupled to the electrode wire for generating an ionization field within the collection tube causing smaller particles entering the collection tube to precipitate onto the walls of the collection tube, electronics including a microcontroller for controlling the operation of the collector, and a housing assembly for housing the collection tube, the high voltage power supply and the electronics. Some embodiments include an interlock system for disabling high voltage to the electrode wire if certain system parameters are not met, a static discharge mechanism for dissipating excess electrostatic charge which may accumulate on the collection tube during operation, and an altitude adjustment mechanism for adjusting the amount of high voltage supplied to the electrode wire based upon the altitude at which the collector is being used. A portable hand-held embodiment of the particle collector is also disclosed.

### CROSS-REFERENCE TO RELATED APPLICATIONS

This application claims priority to U.S. Provisional Patent Application Ser. No. 61/870,544 which was filed on Aug. 27, 2013 and which is incorporated herein by reference.

### STATEMENT REGARDING FEDERALLY SPONSORED RESEARCH OR DEVELOPMENT

The invention described herein was partially supported by government funding from the United States of America. The invention described herein may be manufactured and used by or for the government of the United States of America for government purposes and the government has certain rights in the invention. (U.S. Government Client is United States Department of Homeland Security—Contract: HSHQDC-10-C-00143).

### BACKGROUND OF THE INVENTION

Biocrime investigation is dependent on the ability to reliably collect and preserve biological materials that may be present on surfaces associated with a crime scene. Recovery of sufficient quantities of biological evidence that are comingled with other evidence components such as hairs, fibers and dust confounds the problem of collecting and preserving the integrity and viability of the biological component from the evidence sample matrix. The ability to separate small biological particles of interest from larger associated materials while preserving viability would enhance sample collection, improve biological sample processing, and increase the ability to expand in culture the bioagent used to perpetuate the crime.

The 3M™ Forensics Vacuum 10 is the technology commonly employed for collecting forensic biological samples. This device is shown in FIG. 1 and includes a vacuum unit 12 and a filter cartridge 14. The biological sample is collected in the filter cartridge and then undergoes an extraction process for forensic analysis. The filter is prone to breakthrough failures resulting in sample loss. The filter typically experiences breakthrough due to the amount of material collected, which includes dust and other non-biological materials. In cases where filter integrity is maintained, extraction of the biological sample is inefficient and makes forensic trace analysis difficult as there is no segregation of small biological particles in the collected sample.

The current 3M™ Forensics Vacuum technology commonly employed for collecting forensic samples from dry surfaces suffers from filter collapse which results in loss of vital evidence material. Sample processing of the 3M™ filter is complicated by a difficult to open filter housing and manipulations required to remove the filter typically results in sample loss and contamination of biosafety cabinets used for sample processing. These issues increase the time and expense of sample processing and jeopardize the integrity of the forensic sample, and justify the need for better sampling technology.

The discrete recovery of individual components of interest from a complex forensic sample is also complicated by the overabundance of extraneous materials and further complicated by the potential presence of biological threat agents indicative of a biocrime collection. The ability to de-convolute a complex sample by segregating sample components at the time of sample collection, based on size, charge or other physical or chemical characteristics, enhances the recovery of discrete evidentiary components and provides more rapid sample processing methods.

### SUMMARY OF THE INVENTION

### Development Overview

Applicant developed a dry surface particle collector as a modular attachment to the commercial-off-the-shelf (COTS) 3M™ Forensics Vacuum System in response to filter breakthrough failures typical of the current 3M™ collection system. Four different collector embodiments have been developed to date.

The Forensic Air and Surface Sampler Technology (FASST) Mk I collector is based on electrostatic precipitator (ESP) technology developed by Applicant for similar biological particle sampling missions. The design includes an inertial particle separation technique to deliver the specific particle size range of interest to the ESP for collection onto a coated surface. The collector preferentially targets particles within the 1 to 25 micron size range, the typical size range for biological threat agent materials, and sends such smaller particles through the ESP tube portion of the MK I collector. The ESP tube employs a high voltage (HV) power supply to provide approximately 10,000 volts DC to a wire electrode suspended within a grounded aluminum collection table. This configuration generates a corona discharge to ionize the sample air stream and create free electrons. The smaller particles entering the ESP tube collector encounter the ionization field which causes them to efficiently precipitate onto the collection tube walls. Applicant developed the coating methods and extraction protocols to efficiently remove viable biological agents and nucleic acids from the collector's coated surface.

FASST Mk I prototypes were laboratory tested using B. anthracis Sterne spores and Vaccinia virus to evaluate target compatibility and stability with ESP technology. Pre-validation test results indicated the integration of the ESP into the vacuum collection system did not adversely affect target collection or interfere with the collection system.

The FASST Mk II collector was also developed based upon the test results relating to the FASST Mk I collector. The FASST Mk II collector is similar to the Mk I except that the inertial separator has been removed from the particle stream inside the collector tube. The aerosol dispersion and dust size distribution test conducted on the Mk I collector highlighted the fact that the inertial separator was not necessary and that eliminating the inertial separator on the Mk II collector actually reduces sample loss and increases collection efficiency. In addition, the Mk II design no longer requires a user to remove the ESP electrode wire from the collection tube prior to sample recovery. Once the sample tube is removed from the FASST system, end caps are simply placed onto each end to contain the sample during subsequent recovery steps.

The FASST Mk II collector also provides greater collection of biological particles and improves on the device's ease of use and robustness over the FASST MK I design. During Phase H, the FASST Mk II underwent additional test and evaluations to collect B. anthracis Sterne spores and Vaccinia virus from a variety of solid and carpeted surfaces. A long term stability study was also conducted on the ESP tube coating to optimize the tube storage and validate coating efficacy under a variety of environmental conditions.

The FASST Mk III collector was also developed based upon the test results associated with both the Mk I and the Mk II collectors. The Mk III collector is a portable hand-held collector which includes an electronics housing, a collection tube module having an intake nozzle and a filter adapter, a bottom sliding cover, and a 12 volt battery which is installed within the handle portion of the collector housing. The two main components of the FASST Mk III collector are a single-use collection tube assembly and a reusable battery housed within a main housing which includes the electronics, the DC-voltage power supply, and redundant safety mechanisms for high-voltage protection. In all other respects, the FASST Mk III collector functions similar to the Mk I and Mk II collectors and likewise includes an ESP collection tube assembly as previously explained.

The FASST MK III collector was further improved by modifying some components to make it easier to manufacture and by further adding an automatic altitude adjustment feature and an electrostatic charge dissipation feature to the collector. The present system relies on corona discharge to ionize the system and charge and collect the incoming particulates. The onset of the corona discharge is a function of many environmental variables such as temperature, humidity, air pressure as well as geometric variables such as the radius of the electrode wire. The improved MK III system automatically adjusts the electrode voltage based upon atmospheric pressure measurements from an onboard pressure sensor. This feature is an improvement over the previous systems since corona onset voltage can vary by several thousand volts depending on whether the system is used at sea level or in mountainous regions and can be added to the previous systems.)

The improved MK III system also uses a static discharge element or conductor associated with the collector tube to dissipate any excess charge which may build up on the collection tube. A bundle of fine tipped electrical conductors are electrically connected to the collection tube at one end and the other end of the conductors are positioned at the center of the rear end of the collector tube adjacent to the filter adapter. This arrangement aids in the dissipation of any excess charge on the collection tube back into the airstream entering the vacuum.

The primary benefits of the FASST collectors are their ability to compartmentalize small particles within the size range of biological organisms for rapid recovery in a pre-coated collection vessel designed to stabilize collected organisms and promote rapid live culture recovery. By compartmentalizing the biological particles of interest, the FASST devices eliminate the sample loss problem encountered in current devices (3M filter for example). In situ extraction from the FASST collection vessels also minimizes sample loss and eliminate the potential for cross contamination between samples, a requirement for evidence that could be used in a legal proceeding. Laboratory stability testing demonstrated two-week stability for recovery of nucleic acid signature and spores from ESP tubes which supports operational field requirements for post-collection sample stability. The FASST collection system provides end users with a unique collection system which greatly diminishes sample processing time particularly for viable organisms. The ability to expand the collection of culture biological agents from a crime scene provides the opportunity to gather detailed microbiological analysis including biochemical analysis, serotyping, virulence determination, antibiotic susceptibility in additional to sequencing and genotyping data, critical data points to determine source attribution.

There are virtually limitless scenarios that can be envisioned for introducing pathogens into the environment. A wide array of potential surfaces can be exposed to these bioweapons. The variety of methods for disseminating bioweapons and the many surfaces and matrices that the weapons may encounter present significant challenges for effective environmental sampling for bioweapons. Nevertheless, pathogens such as bacteria remaining in the environment subsequent to a biological attack provide a potentially rich source of evidence for use in criminal investigations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of the prior art COTS 3M™ Trace Evidence Vacuum and Dry Filter.

FIG. 2 is a photograph of the FASST Mk I Prototype (with 3M filter and Vacuum attached).

FIG. 3 is a schematic of the particle dynamics inside the MK I Forensics Collector Assembly.

FIG. 4 is a graph showing aerosol dispersion test results for the ESP and 3M Filter.

FIG. 5 is a photograph showing typical debris greater than 2000 μm sieved from: a) Office Floor and b) Honda Civic.

FIG. 6 is a graph showing typical office vacuum collection: a) % Volume vs. Particle Diameter b) % Particle Count vs. Particle Dia.

FIG. 7 is a graph showing typical vehicle collection (Honda Civic): a) % Volume vs. Particle Diameter b) % Particle Count vs. Particle Dia.

FIG. 8 is an exploded view of the FASST Mk II components.

FIG. 9 is a side elevational view of the FASST MK II Collector (Assembled).

FIG. 10 is a perspective view of the 3M™ vacuum hose/choke assembly.

FIG. 11 is a perspective view of a fully assembled FASST Mk II Collection System.

FIG. 12 are perspective views of a sample collection tube fitted with sealing end caps.

FIG. 13 is an exploded perspective view of the FASST MK II collector components evaluated in capacity testing.

FIG. 14 is a top plan view of the dry surfaces used for sample collection—a) Rough tile surface, b) low pile carpet surface.

FIG. 15 is a Real-Time PCR Amplification of Bacillus anthracis recovered from FASST ESP Collection Tubes Standards 1e5 (Green), 1e4 (Red), 1e3 (Orange), 1e2 (Gray), Samples (Blue), PCR No Template Controls (Black).

FIG. 16 is a Real-Time PCR Amplification of Vaccinia recovered from FASST ESP Collection Tubes Standards 1e5 (Green), 1e4 (Red), 1e3 (Orange), 1e2 (Gray), Sample (Blue), PCR No Template Controls (Black).

FIG. 17 is a chart showing the sample distribution of 5 grams of Ultra-Fine Arizona Road Dust collected by the FASST Mk II Sampler.

FIG. 18 is a chart showing the sample distribution of 5 grams of Standard Reference Material collected by the FASST Mk II Sampler.

FIG. 19 is a chart showing the sample distribution of 5 grams of office debris collected by the FASST Mk II Sampler, demonstrating the size segregation capabilities.

FIG. 20 is a chart showing the sample distribution of 5 grams of Auto Debris collected by the FASST Mk II sampler, demonstrating the size segregation capabilities.

FIG. 21 is a chart showing Real-Time PCR Amplification of B. anthracis Spores collected from Dry Surfaces Standards 1e5 (Green), 1e4 (Red), 1e3 (Orange), 1e2 (Gray), Samples (Blue), PCR No Template Controls (Black).

FIG. 22 is a Real-Time PCR Amplification Curve Vaccinia collected from Dry Surfaces Standards 1e5 (Green), 1e4 (Red), 1e3 (Orange), 1e2 (Gray), Sample (Blue), PCR No Template Controls (Black).

FIG. 23 is a chart showing B. anthracis and Vaccinia Real-Time PCR results for the stability study.

FIG. 24 is a chart showing B. anthracis plate count results for the stability study.

FIG. 25 is a chart showing Pre-Validation FASST Mk II Collections Real-Time PCR results for rough tile surface.

FIG. 26 is a chart showing Pre-Validation FASST Mk II Collections Real-Time PCR results for carpet surface.

FIG. 27 is a chart showing Pre-validation COTS 3M™ Collections Real-Time PCR results for carpet and rough tile surfaces. Samples 4 and 8 (hashed bars) were processed for live culture prior to nucleic acid extraction.

FIG. 28 is a chart showing Pre-Validation Live Culture Recovery from rough tile and carpet surfaces. Green bars represent amount of viable target recovered from ESP rinsate tubes using the FASST Mk II Collector. Purple bars represent amount of viable target recovered from standard 3M filters using the COTS 3M Forensic Vacuum System.

FIG. 29 is an exploded perspective view of the FASST MK III collector components.

FIG. 30 is a cross-sectional view of the FASST MK III collector tube assembly.

FIG. 31 is an exploded perspective view of the electronics housing/center case assembly.

FIG. 32A is a side elevational view of the high voltage supply assembly.

FIG. 32B is a side elevational view of the high voltage supply assembly with certain parts removed from view for clarity purposes.

FIG. 32C is a top plan form view of the high voltage supply assembly.

FIG. 32D is a top plan view of the high voltage supply assembly with certain parts removed from view for clarity purposes.

FIG. 33 is a perspective view of the intake nozzle associated with the collection tube assembly of the FASST MK III collector.

FIG. 34 is a perspective view of the filter adapter associated with the collection tube assembly of the FASST MK III collector.

FIG. 35 is a perspective view of the bottom slide cover associated with the FASST MK III collector.

FIG. 36 is an exploded perspective view of the handle assembly associated with the FASST MK III collector.

FIG. 37 is a perspective view of the FASST MK III collection tube module shown in both its collection configuration and its containment configuration.

FIG. 38 is an exploded perspective view of the FASST Mark III Components.

FIG. 39 is an exploded perspective view of FASST MK III Collection Tube Assembly Procedure.

FIG. 40 is an exploded perspective view of the FASST MK III electronics housing and collection tube.

FIG. 41 is a bottom perspective view of the electronics housing.

FIG. 42 is a perspective view of electronics housing and collection tube assembly.

FIG. 43 is an exploded view of the FASST Mark III collector with the bottom sliding cover removed.

FIG. 44 is a perspective view of the FASST MK III collector with the bottom slide cover in its assembled condition.

FIG. 45 is a perspective view of a fully assembled FASST MK III collector.

FIG. 46 is an exploded perspective view of the FASST MK III collector showing the 12 volt battery removed.

FIG. 47 is a perspective view of the FASST MK III collector with the 12 Volt Battery in its assembly condition.

FIG. 48 is a perspective view of the 3M™ vacuum hose/choke assembly associated with the FASST MK III collector.

FIG. 49 is a perspective view of the 3M™ Dry Filter connected to the vacuum hose/choke assembly.

FIG. 50 is a perspective view of a fully assembled FASST MK III Collector.

FIG. 51 is a cross-sectional view of the improved FASST MK III collection tube module showing the electrostatic discharge conductor associated therewith.

FIG. 52 is an enlarged end view of the improved FASST MK III collection tube module showing the installation of electrostatic discharge conductor in greater detail.

FIG. 53 is a perspective view of the improved FASST MK III collection tube module showing the static discharger within the collection tube.

FIG. 54 is a cutaway view of the improved FASST MK III collection tube module showing the configuration of the static discharger within the collection tube.

### DETAILED DESCRIPTION OF THE INVENTION

The following detailed description of the present invention references the accompanying drawing figures that illustrate specific embodiments in which the invention can be practiced. The several embodiments disclosed herein are intended to describe aspects of the present invention in sufficient detail to enable those skilled in the art to practice the invention. Other embodiments can be utilized and changes can be made without departing from the spirit and scope of the present invention. The present description is not to be taken in a limiting sense and shall not limit the scope of equivalents to which the appended claims are entitled.

### FASST Mk I Overview

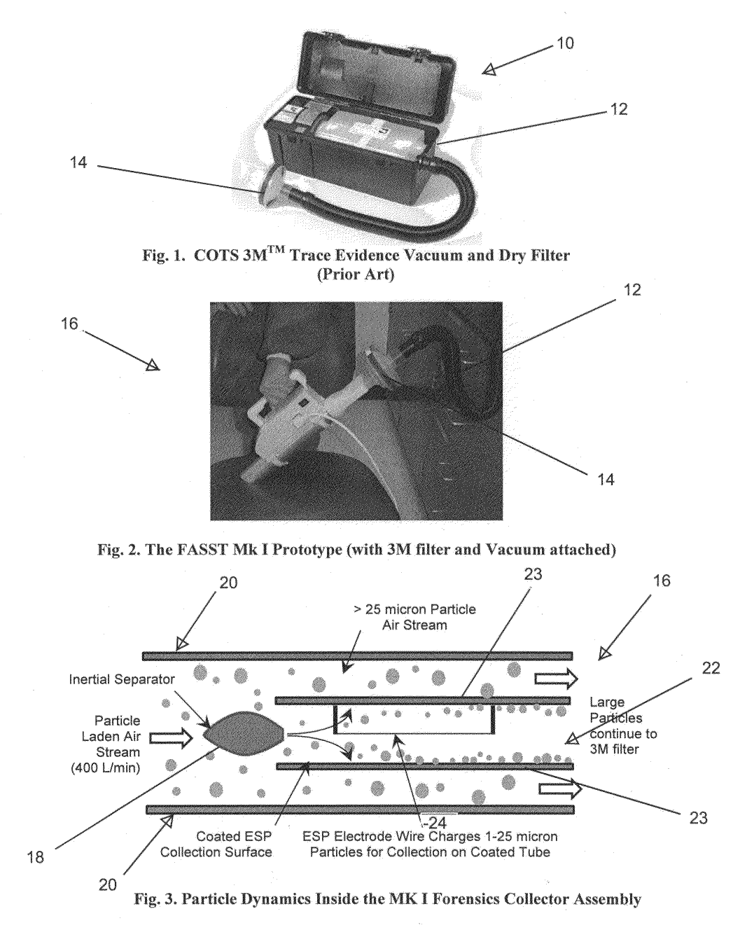

Applicant initially designed and tested a prototype of the Forensic Air and Surface Sampler Technology (FASST) system 16 for biological evaluation as illustrated in FIGS. 2 and 3 during Phase I of the program. The device 16 includes an outer tube 20 and an inner electrostatic precipitator (ESP) collection tube 22 and uses an inertial separator 18 coupled to the ESP collection tube 22. The inertial separator 18 was designed to remove large particles from the airflow stream entering the ESP collection tube 22 and shunt them to the outer tube 20 and to the standard 3M™ dry filter for collection. The smaller particles entering the collection tube 20 encounter an ionization field generated by the electrode wire suspended within the ESP tube 22 that causes them to precipitate on the walls 23 of the ESP tube 22. FIG. 3 is a schematic showing the particle flow inside the Mk I collector. The Mk I system has excessive particle loss in the outer bypass tube (the flow path through which the large material (large particulates, hair, fibers, etc.) is diverted by the inertial separator) as illustrated in FIG. 3. Since this outer tube is not generally cleaned to extract samples, particles collected on the outer tube may be considered lost sample.

### FASST Mk I Baseline Testing

Applicant initiated a series of tests to better understand the true collection efficiency of the ESP and determine the baseline performance of the FASST Mk I system. By understanding the efficiency of the current design, future design modifications could be implemented to improve the overall collection efficiency of the device.

### Aerosol Dispersion Testing

This testing used ammonium fluorescein disseminated at multiple particle sizes to trace depositions within the FASST Mk 1 device. Test operators used a Vibrating Orifice Aerosol Generator (VOAG, Model No. 3450, TSI, Inc., St. Paul, Minn.), to introduce monodisperse particles of ammonium fluorescein into the flow system. The VOAG generates droplets in approximately 2.5-cfm airflow. The ammonium fluorescein droplets dry to solid particles while traveling through a charge neutralizer and drying tube before injection into the test system. The test operators positioned the VOAG's charge neutralizer so that the exiting ammonium fluorescein aerosol entered into the flow system through a PVC tee-connector. The required make-up air entered the flow system through HEPA filters (3M GVP-440) positioned on the ends of the PVC tee-connector at the inlet of the flow tube.

Test operators positioned the FASST MK I device within the flow system, downstream of the inlet tee-connector. They also placed an EPM 2000 glass fiber filter (#1882866 Whatman, Ltd., Maidstone, England) downstream from the FASST device. This exhaust filter captured any ammonium fluorescein particles that passed through the MKI prototype system. The operators monitored the air stream flow rate using a roots meter and blower located at the end of the flow system. All dispersion tests were performed at the flow rate of 400 L/min using 1.1, 1.7, 5.5, 10.4 and 16.4 μm ammonium fluorescein particles.

To determine the collection efficiency, operators compared the amount of ammonium fluorescein captured in the FASST Mk 1 system to the total mass of ammonium fluorescein captured in the flow system. At the conclusion of each test, the test operators disassembled each component of the FASST Mk I system, exhaust tube and exhaust filter and then individually rinsed each component using 0.1 N ammonium hydroxide (NH₄OH). An aliquot of the thoroughly mixed rinsate was then acquired for fluorometric analysis. Scientists performed analysis of ammonium fluorescein rinsates using Applicant's PerSeptive biosystems fluorimeter, a Cytofluor multi-well plate reader, Series 4000 (Applied Biosystems, Foster City, Calif.).

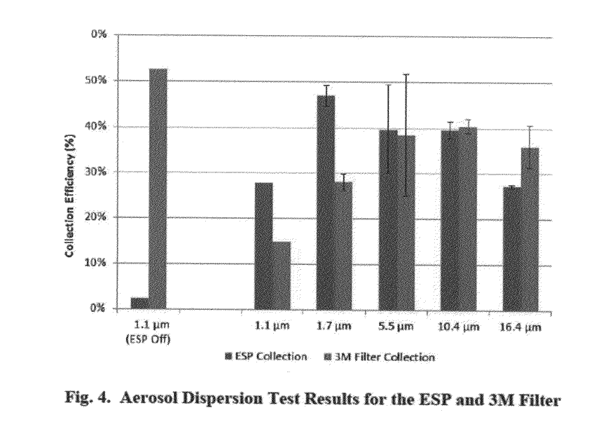

Results of the aerosol dispersion test are illustrated in FIG. 4. It should be noted that this data was collected from a small sample of tests (<2 replicates). These results show that a significant percentage of particles are collected on non-recoverable surfaces. For example, the 1.1 micron data indicates that approximately 50% of the material is collected on surfaces other than the ESP collection tube and the 3M™ filter. These losses are reduced to 20% as the particle size increases to 10 microns. Consequently, the ESP portion of the sample contained less 1-25 micron material than originally intended. This was a direct result of using the inertial separator 18, which allows >40% of the 1-25 micron material to flow completely around the ESP portion and into the 3M™ dry filter.

### Dust Size Distribution Tests

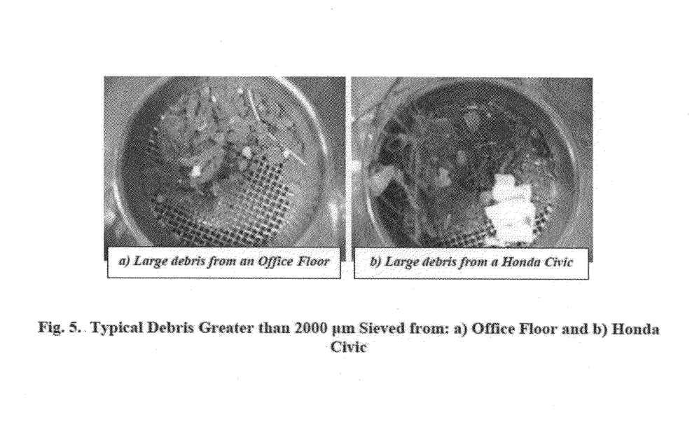

The objective of the dust size distribution studies was to determine an approximate sample mass and particle distribution for vacuum collection in a typical field collection. Samples were collected from several office floors and seventeen employee vehicles from the Applicant's Florida facility. The tested vehicles included 2 and 4-door cars, large and small trucks, SUV's, and a mini-van. It was found that a typical car yielded approximately 15 g of particulate with approximately 5 g of that material coming from the trunk area. These masses do not include bulk material such as grass, leaves, or similar materials greater than 2000 micron in size as this material was sieved from the sample prior to particle, size analysis. See, FIG. 5.

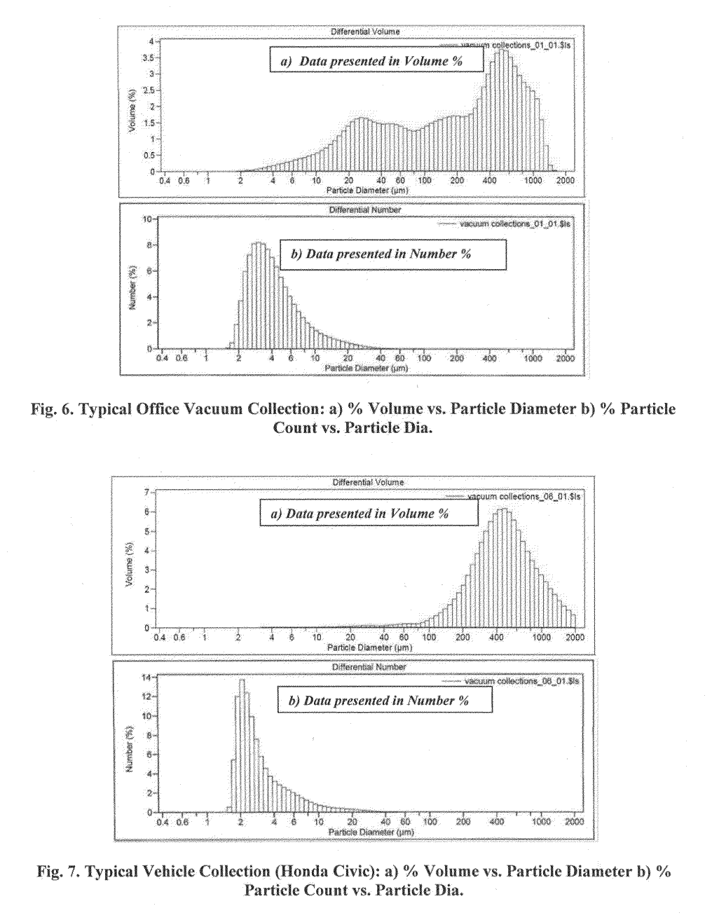

Particle size analysis using the Beckman Coulter Particle Analyzer (FIGS. 6 and 7) shows the heterogeneous nature of these real-word samples. While both the office and vehicle samples indicate the collection of some massive particulate (>20 micron) based on the particle size diameter (by % volume), a majority of the collected particulate are, in fact, less than 10 micron (by % number). This data indicates that the inertial separator 18 included in the FASST Mk I system is not a critical feature since most of the collected particulate will be less than 10 micron and comparable to the size of unclumped target biological material.

### Baseline Testing Results

The aerosol dispersion and dust size distribution tests highlighted the fact that the inertial separator 18 used in the Mk I system is not necessary and that eliminating it on the Mk II system reduces sample loss and increases collection efficiency. The ESP within the FASST Mk II still preferentially collects small particulate matter (<25 micron) due to the fact that larger particles have too much inertia to be captured and retained efficiently on the walls of the ESP collection zone. Thus, the Mk II design still segregates the sample based on particle size. Additionally, omission of the inertial separator reduces the complexity of the FASST Mk II device and simplifies the sample extraction process.

### FASST Mk II

### Design Goals

Operational testing was conducted using several dispersion methods to simulate realistic conditions of agent release and to characterize the FASST Mk I performance under a variety of test conditions. Throughout these tests, as well as the baseline testing during Phase II, three key areas of improvement for the Mk II were identified: 1) Performance Enhancement—changes intended to increase sampling and extraction efficiency, 2) User Operability—changes intended to improve the device's ease of use, and 3) Design Robustness—changes intended to improve the robustness of the prototype system. These three areas were addressed during the Phase II design process and the results are described in the following sections.

### Mk II System Design Overview

Similar to the FASST Mk I system, the core technology in the FASST Mk II is an electrostatic precipitator (ESP) that employs a high-voltage (HV) power supply to provide approximately 10,000 volts DC to a wire electrode similar to wire electrode 24 suspended within a grounded aluminum collection tube similar to ESP tube 22. This configuration generates a corona discharge to ionize the sample air stream and create free electrons. Smaller (1 to 20 μm) particles entering the ESP tube encounter the ionization field, causing them to efficiently precipitate onto the collection tube walls. Due to their inertia, larger particles pass through the ionization field and are captured by a secondary dry filter located downstream of the ESP. The 3M™ vacuum is the primary air mover for the FASST Mk II.

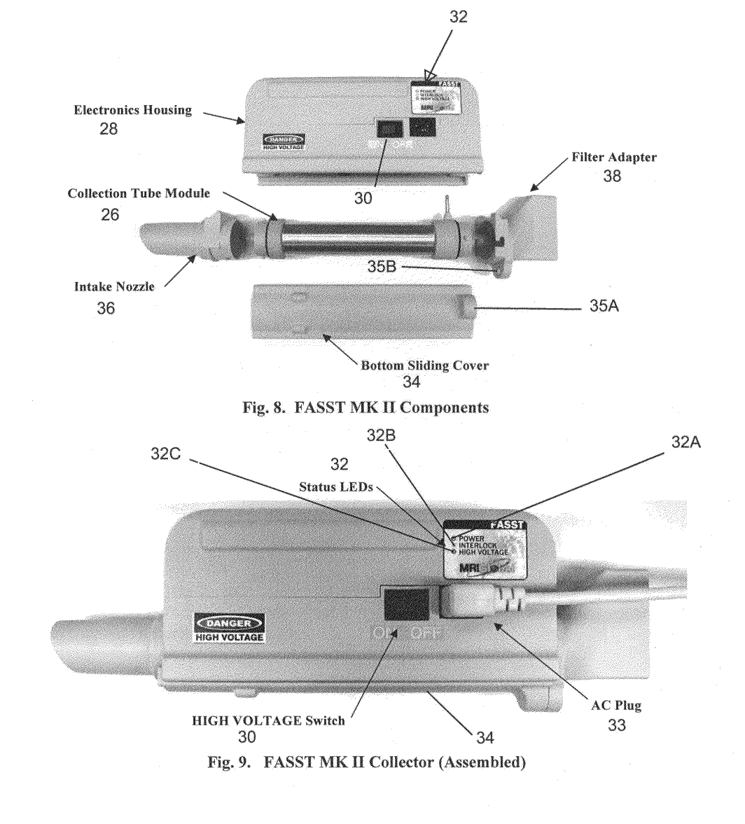

The MK II system's two main components are a single-use collection tube assembly 26 and a reusable AC-powered main housing 28 which contains the electronics, the DC high-voltage power supply, and redundant safety mechanisms for high-voltage protection as illustrated in FIG. 8. Removing the collection tube assembly for analysis takes less than 20 seconds and is a tool-free process.

### FASST Mk II Operation

The FASST Mk II system has a simple high voltage ON/OFF switch 30 to enable high voltage and three LEDs 32 indicating operational status as best shown in FIG. 9, green LED 32A indicating that power is supplied to the unit, yellow LED 32B indicating that the interlock has been activated, and red LED 32C indicating that the High Voltage switch is on and supplied to the unit. A microprocessor controls the operation of the hardware, including the high voltage power supply, status LEDs 32 and safety mechanisms. It requires 120VAC (standard wall outlet voltage/current) to operate and includes a power connection 33 for plugging into a standard wall outlet power source. The unit powers on as soon as it is plugged into standard wall power, so the High Voltage switch 30 should be in the OFF position to begin. As soon as the Mk II system is plugged in and supplied with standard 120VAC, all three status LED's 32 will blink simultaneously for approximately 5 seconds. Once the blinking stops, the green and yellow LED's 32A and 32B will remain on steady. This indicates that the Mk II system is ready for high voltage to be enabled. Once the High Voltage switch 30 is moved to the ON position, the Ted High Voltage LED 32C will be on steady. This indicates that high voltage is being supplied to the FASST Mk II's electrostatic precipitator and the unit is functioning properly.

The FASST Mk II system has several safety mechanisms that protect the unit and operator from damage and injury due to high voltage exposure. The FASST Mk II system will not enable high voltage unless it is fully assembled. There are two safety interlocks that will prevent high voltage from turning on if the full collection tube assembly and bottom sliding door 34 (FIG. 8) are not fully installed. Additionally, if either of these two components are removed from the unit during operation or become dislodged or not properly installed or positioned within the housing, high voltage will immediately be disabled. The safety interlocks are Hall Effect (magnetic) sensors that signal the micro-processor when an ESP tube is installed and the safety cover closed. This safety mechanism is indicated by the yellow Interlock LED 32B. Under normal conditions, the yellow LED 32B is on steady. It will blink in different patterns if any component is missing from the unit. The switches are hidden from the user's sight within the electronics enclosure to reduce the likelihood of a user circumventing the safety interlocks. A detailed description of the safety interlocks is set forth below with reference to the MK III system. It is recognized that any other safety/sensing mechanism may likewise be used in this particular application such as micro switches and optical sensors.

The electronics in the Mk II receive feedback from the internal high voltage power supply. Excessive current draw, under voltage, and excessive power supply temperature are all monitored and can be signs of a possible electrical short or other malfunction. The high voltage power supply will be shut down if any of these scenarios are detected. This will be indicated by a blinking red High Voltage LED 32C in regards to an excessive current draw or under voltage, and a blinking green LED 32A for an overheating scenario. Table 1 shows all possible LED status scenarios for the FASST Mk II system.

TABLE 1
LED Stats Indicator Table

| PWR | | | | | | |
|---|---|---|---|---|---|---|
| PLUG | TUBE INSTALLED | DOOR INSTALLED | GREEN LED | YELLOW LED | RED LED | HV STATUS |
| OFF | NA | NA | OFF | OFF | OFF | OFF |
| ON | NO | NO | ON | OFF | OFF | OFF |
| ON | YES | NO | ON | BLINK SLOW | OFF | OFF |
| ON | NO | YES | ON | BLINK FAST | OFF | OFF |
| ON | YES | YES | ON | ON | BLINK SLOW (1/SEC.) | HV CUR BAD |
| ON | YES | YES | ON | ON | BLINK FAST (10/SEC.) | HV VOLT BAD |
| ON | YES | YES | BLINK FAST | ON | ON | OVER TEMP |
| ON | YES | YES | ON | ON | ON | HV GOOD |
| ON | YES | YES | ON | ON | OFF | HV OFF-SWITCH |

The FASST Mk II system should be unplugged during assembly and disassembly and when the device is not in use. All FASST Mk II components need to be completely dry before assembly and use with residual moisture in the system can increase the hazard of electrical arcing. Applicant has designed the FASST MK II system with the ability to access the inside of the electronics housing for diagnosis and repair. This is an operation that can only be performed by designated personnel, and at no time should the electronics housing be opened by unauthorized personnel.

### FASST Mk II Assembly and Collection Tube Removal

The FASST Mk II assembly and collection tube module removal procedures are simple, tool free processes. A disassembled Mk II unit is illustrated in FIG. 8. To begin assembly, the intake nozzle 36 and filter adapter 38 are attached to the collection tube module 26. This assembly is clipped into the electronics housing. Finally, the bottom sliding cover 34 is attached and secured in place with a simple magnetic closure 35A and 35B. The fully assembled Mk II system is illustrated in FIG. 9. The collection tube module 26 is removed by reversing this procedure.

### FASST Mk II Collection System Assembly

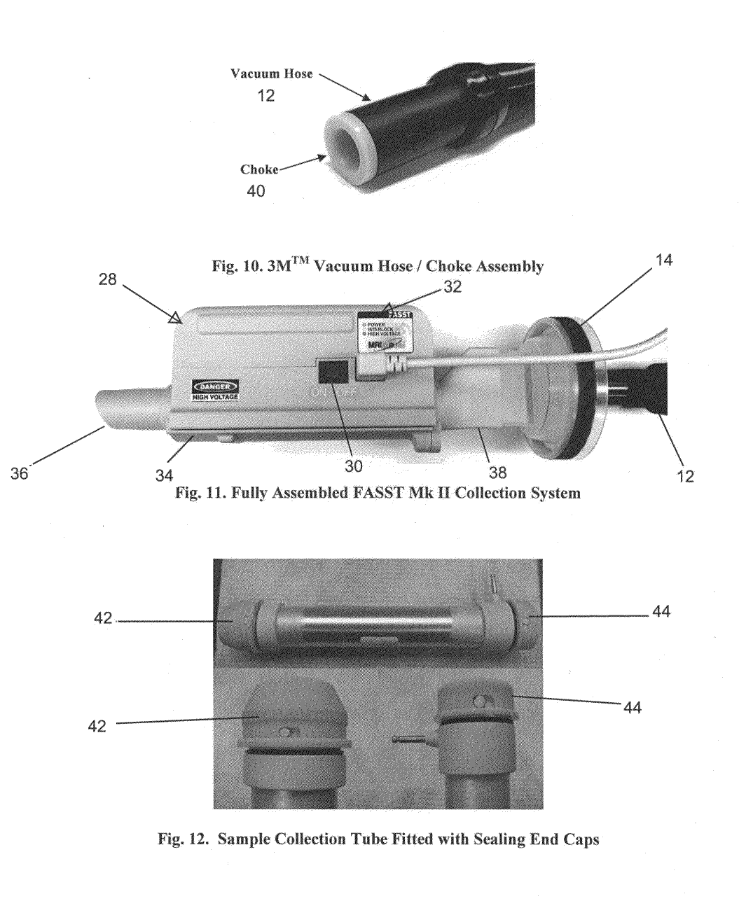

The FASST Mk II system is designed to work in conjunction with the 3M™ Trace Evidence Vacuum 12 and Dry Filter 14 which are seen in FIG. 1. A choke 40 is used to reduce the flow of the 3M™ vacuum hose 12 (FIG. 10) down to 400 L/min, which is the optimal air flow for the Mk II. The fully assembled FASST Mk II Collection System is illustrated in FIG. 11.

### Testing and Evaluation of the FASST Mk II

The Mk II system design incorporates several improvements over the Mk I design to simplify the recovery of collected material. The Mk II design no longer requires a user to remove the ESP electrode wire from the collection tube prior to sample recovery. Once the sample tube is removed from the FASST system, end caps such as caps 42 and 44 are simply placed onto each end to contain the sample during subsequent recovery steps as illustrated in FIG. 12. This method not only eliminates the cumbersome step of removing the electrode wire, it also allows for recovery of sample material that may have been collected on the electrode wire.

A series of tests were designed and executed to evaluate the FASST MK II design. These tests were designed to further examine the FASST device and understand the environment and the properties of the particles the device will encounter in a field scenario. Challenging the FASST Mk II device in varying ways facilitates understanding of how the design changes improved collection as well as determine how the device will perform in scenarios an end-user might encounter. The series of tests are detailed below.

### Initial Evaluation

The Initial Evaluation Study was performed to become familiar with the new prototype to ensure modifications were compatible with the existing extraction Standard Operating Procedure (SOP) for sample extraction (SOP 110724.002: Extraction of B. anthracis and Vaccinia from the Forensic Air and Surface Sampler Technology (FASST) System for use in Live Culture and PCR Analysis) which was developed during Phase I.

### Capacity and Particle Size Testing

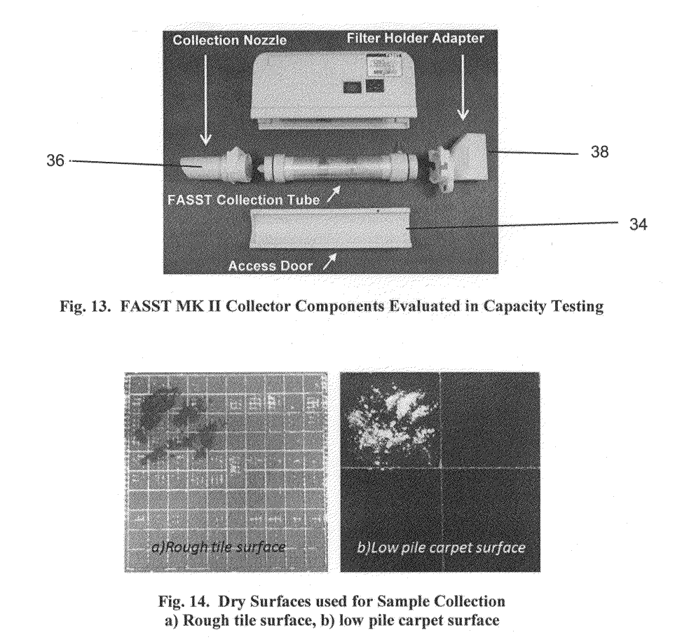

Applicant performed capacity testing of the FASST Mk II prototype to evaluate performance of the sampler when challenged with increasing levels of dry dust and debris. This testing included sample types that might be encountered in real world sampling scenarios. For these studies, the test protocol required that un-seeded dry dust be distributed onto a tile surface and then collected by the FASST Mk II prototype. Increasing levels of dust ranging from 0.5 grams to 10 grams per surface collection were tested to evaluate the collection capacity of the sample collection tube and to evaluate performance of the system for its intended use. The downstream 3M™ filter 14 was replaced with the Fibertect® matrix with customized DHS filter holder to prevent potential sample loss in the event of 3M™ filter rupture. Applicant weighed the component parts of the prototype before and after collection to determine how the collected sample is distributed in the component parts of the FASST Mk II prototype. FIG. 13 provides a picture of the FASST system components that Applicant weighed before and after sample collection:
Collection nozzle 36
FASST sample collection tube 26
Filter holder adapter 38
Downstream Fibertect® filter and filter housing unit (not pictured)—The customized Matrix filter holder and Fibertect® filter were used as the downstream filter unit to avoid sample loss due to potential failure of the standard 3M™ filter.

Applicant evaluated four types of dry dust in the study to include samples spanning a variety of particle sizes in addition to real world samples:
Ultra-Fine Arizona Road Dust (UF-ARD): (1-10 μm, Powder Technologies Inc., A1 Ultrafine Test Dust, ISO 12103-1)
Standardized Reference Material (SRM): (0-40 μm produced by MRIGlobal for the DHS BIAD II program)—consisting of dust and particulates collected from HVAC systems across the US.
Office vacuum dust: (un-sieved)—collected from MRIGlobal offices
Automobile dust: (pre-sieved of particles >2 mm)—collected from MRIGlobal staff automobiles.

Applicant bulk-collected the representative real world samples used in this study (office dust and automobile dust) from an office setting and automobile interiors to represent typical collection events anticipated in the field. Applicant vacuum collected particulates from Applicant's office floors using a standard upright vacuum from office areas with varying levels of foot traffic, to be representative of standard office environments. The office debris used for the FASST capacity testing was not sieved of large particles and is representative of true real world sample. Automobile samples were collected from cars using a standard Shop Vac. The automobile dust and representative office debris were analyzed on a Beckman Coulter Particle Analyzer to generate statistics on typical particle size number and percent volume distributions.

The real world samples, office and automobile debris, discussed previously were evaluated in this study and show the heterogeneous nature typical of natural samples. The office sample contained a wide variety of particle sizes greater than 20 μm while the vehicle sample contained particles with an average size of 500 μm. In both samples, the majority of particles had diameters smaller than 10 μm which is similar in size to that of unclumped biological material. These masses do not include bulk material such as grass, leaves, or similar materials greater than 2000 μm in size which were sieved from the samples for particle size analysis.

### Seeded Dry Surface Collections

Based on the results of the capacity testing, the Standard Reference Material (SRM) was determined to be the best candidate background material to suspend lyophilized B. anthracis spores and Vaccinia for distribution onto test surfaces. Dry surface collections studies were conducted to evaluate the collection and recovery capability of the FASST Mk II collector. Eightly grams of bulk seeded SRM was prepared using lyophilized B. anthracis spores and Vaccinia virus which were mixed into pre-sterilized SRM to be used for surface collection studies. Seeded SRM was prepared as a dilution series using the SRM background as a dry diluent. Spores and virus were mixed into the SRM by thorough mixing with a spatula and hand agitation to homogenize the mixture. Mixtures used were of one-thousand fold, ten thousand fold and one hundred thousand fold dilution series of the starting lyophilized materials. Target levels of B. anthracis and Vacinnia in the final preparation of 2.0 grams of seeded SRM were enumerated by PCR. Plate count data was also used to estimate the levels of B. anthracis. Lyophilized Vaccinia when mixed into the SRM was found to be not viable using the established Cytopathic Effect (CPE) method. Loss of Vaccinia viability may be due to abrasive mixing of the lyophilized particles into the SRM. The estimated levels of target in 2.0 grams of seeded SRM used for subsequent dry surface collections was 1.6⁶ CFU/gram of B. anthracis spores and 2e⁷ PFU/gram of Vacinnia particles.

### Stability Study

Using the established extraction method and detection methods, a stability study was conducted to evaluate the post-collection target stability in the ESP tube. Representative 2.0 gram samples of the SRM seeded with lyophilized B. anthracis Sterne spores and Vaccinia virus were collected from a tile surface with the FASST Mk II collector. A total of ten samples were prepared to establish duplicate collected samples for testing at each time point. ESP collection tube and 3M™ filter samples were stored at room temperature and processed in duplicate at the following time points: Day zero, 3 days, 7 days, 10 days and 13 days. Samples were tested by PCR and plated for live culture recovery of B. anthracis Sterne at each time point.

### Pre-Validation

The FASST Mk II forensic collection system was challenged to simulate operational surface collection from rough tile and carpet surfaces in a pre-validation study. Sixteen replicate surface collections with the FASST Mk II system were conducted to demonstrate repeatability and reliability of performance. FASST Mk II system performance was compared to the standard 3M™ collection system during pre-validation testing. Dry surface collection of seeded SRM was performed using a single target level. A 2.0 gram sample of seeded SRM was administered to a rough surface ceramic tile and low pile carpet surface (FIG. 14).

Each 2.0 gram sample collected contained an estimated 3e⁶ CFUs of spores and 4e⁷ PFU virus particles. Each sample was vacuum collected with the FASST Mk II collector for a total of one minute using a grid pattern across the surface. Four replicate samples for each surface type were collected by the standard 3M™ system for comparison to the FASST Mk II forensic collector and processed using existing methods for recovery of B. anthracis and Vaccinia nucleic acids and viable B. anthracis spores. Two representative samples from the standard 3M™ collections were processed for live culture using a protocol provided by DHS. Briefly, the 3M™ filter was recovered from the filter housing and pre-wet with 10-mLs of phosphate buffered saline (PBS) and vortexed gently for 30 seconds. A 100 μL aliquot of rinsate was plated neat and serial diluted and plated on solid agar media. The rinsed filter was then processed for nucleic acid recovery according to standard methods.

### Testing and Evaluation of the FASST Mk II Collector Initial Evaluation

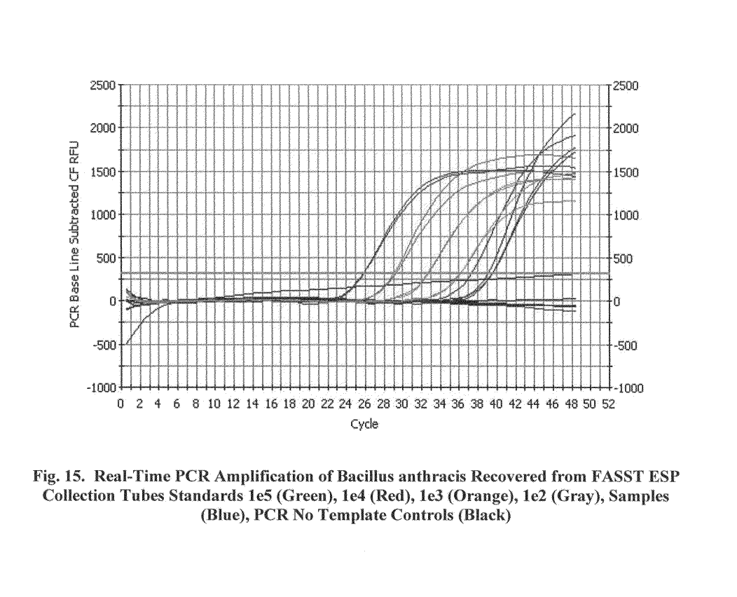

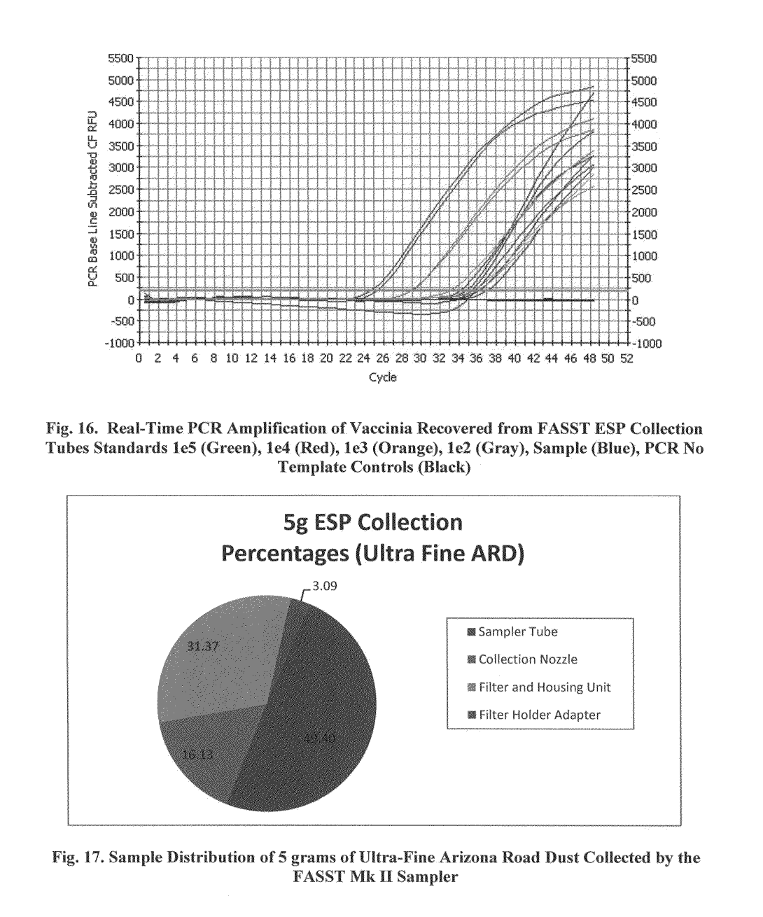

Three replicate tubes were spiked with 1e3 CFU/PFU B. anthracis Sterne spores and Vaccinia virus then extracted with 6-mL of PBS in accordance with the SOP. Real time PCR analysis was conducted on resulting nucleic acids for Vaccinia and B. anthracis gene targets. Extract was plated on TSA/SBA solid agar media for live culture recovery of B. anthracis. PCR data is compiled in Table 2 and Table 3 below as well as in FIGS. 15 and 16. Control samples were used and are identified in the Tables as Sample Type as follows:
(1) Controls—either no bio sample material (target) included in the sample or test sample added;
(2) actual tube samples; and
(3) IE BA standard samples with a known quantity of standard bio material.

The Ct column refers to the cycle threshold and indicates the actual or mean number of cycles necessary to read the sample or replicate the DNA with confidence.

TABLE 2
Real-Time PCR Results for Bacillus anthracis Recovered from
FASST ESP Collection Tubes

| SAMPLE | | | |
|---|---|---|---|
| TYPE | SAMPLE | Ct | MEAN Ct |
| Controls | Master mix No template control | N/A | NA |
| | Master mix No template control | N/A | |
| | Sample add No template control | N/A | NA |
| | Sample add No template control | N/A | |
| Test #1 | Tube 1 | NA | NA |
| Samples | Tube 1 | NA | |
| | Tube 2 | 39.0 | 39.3 |
| | Tube 2 | 39.6 | |
| | Tube 3 | 39.5 | 38.4 |
| | Tube 3 | 37.3 | |
| Standards | 1E5 BA standard | 25.8 | 25.8 |
| | 1E5 BA standard | 25.8 | |
| | 1E4 BA standard | 29.1 | 29.2 |
| | 1E4 BA standard | 29.3 | |
| | 1E3 BA standard | 32.6 | 32.7 |
| | 1E3 BA standard | 32.7 | |
| | 1E2 BA standard | 36.1 | 36.2 |
| | 1E2 BA standard | 36.2 | |

TABLE 3
Real-Time PCR Results for Vaccinia Recovered from
FASST ESP Collection Tubes

| SAMPLE TYPE | SAMPLE | Ct | AVERAGE Ct |
|---|---|---|---|
| Controls | Master mix No template | N/A | NA |
| | control | | |
| | Master mix No template | N/A | |
| | control | | |
| | Sample add No template | N/A | NA |
| | control | | |
| | Sample add No template | N/A | |
| | control | | |
| Test #1 Samples | Tube 1 | 33.9 | 34.3 |
| | Tube 1 | 34.7 | |
| | Tube 2 | 35.3 | 35.6 |
| | Tube 2 | 35.8 | |
| | Tube 3 | 36.1 | 36.5 |
| | Tube 3 | 36.8 | |
| Standards | 1E5 Vac standard | 24.5 | 24.9 |
| | 1E5 Vac standard | 25.2 | |
| | 1E4 Vac standard | 28.8 | 28.9 |
| | 1E4 Vac standard | 28.9 | |
| | 1E3 Vac standard | 32.9 | 32.9 |
| | 1E3 Vac standard | 32.9 | |
| | 1E2 Vac standard | 35.8 | 35.6 |
| | 1E2 Vac standard | 35.3 | |

Recovery of the Vaccinia target is consistent with historical data for similar spike level from Phase I test and evaluation studies (data not shown). The B. anthracis recovery however was lower than expected and upon review an error in calculation of B. anthracis spike stock was discovered. The true spike level used in the experiment was 8e² CFU which is below the reliable limit of detection for the protocol which resulted in late Cts and failed detection from one tube replicate. Although the seed level was lower than intended, B. anthracis colonies were recovered on live culture plates from all three tubes with average colony counts of 58 colonies from neat extract. Overall, the redesigned prototype assembly is compatible with the extraction protocol developed in Phase I with no need for further development of the protocol.

### Capacity and Particle Size Testing

Capacity testing of the FASST Mk II collector was conducted by testing increasing levels of unseeded dry dust and debris of four different sample types to determine the sample distribution within the components of the collector. Component parts which included: the collection nozzle 36, the FASST sample collection tube 26, the filter holder adapter 38 and the downstream Fibertect® filter were weighed before and after collection. Sample recovery from the FASST Mk II sample collection tube for each type of debris tested is compiled in Table 4 below.

TABLE 4
Capacity Testing and Sample Recovery from the
FASST Mk II Sample Collection Tube

| | Pre-weight | Post-weight | | % |
|---|---|---|---|---|
| | (g) | (g) | Δ (g) | Recovered |
| UF ARD | | | | |
| TestMass | | | | |
| 0.5 grams | 61.4412 | 61.4785 | 0.0373 | 7.46 |
| 1.0 grams | 62.1805 | 62.8357 | 0.6552 | 65.52 |
| 2.0 grams | 61.0560 | 62.5701 | 1.5141 | 75.71 |
| 3.0 grams | 61.8122 | 63.7151 | 1.9029 | 63.43 |
| 4.0 grams | 61.9119 | 64.3548 | 2.4429 | 61.07 |
| 5.0 grams | 62.1027 | 64.5728 | 2.4701 | 49.40 |
| 10.0 grams | 62.2526 | 66.4700 | 4.2174 | 42.17 |
| SRM Test Mass | | | | |
| 0.5 grams | 62.2221 | 62.6902 | 0.4681 | 93.62 |
| 1.0 grams | 62.3717 | 63.2544 | 0.8827 | 88.27 |
| 2.0 grams | 62.0566 | 63.7769 | 1.7203 | 86.01 |
| 3.0 grams | 60.7582 | 63.4269 | 2.6687 | 88.96 |
| 4.0 grams | 62.2906 | 65.7606 | 3.4700 | 86.75 |
| 5.0 grams | 62.4910 | 67.0600 | 4.5690 | 91.38 |
| 10.0 grams | 61.8779 | 71.2658 | 9.3879 | 93.88 |
| Office Debris | | | | |
| 0.5 grams | 62.0973 | 62.2051 | 0.1078 | 21.56 |
| 1.0 grams | 61.7620 | 61.9117 | 0.1497 | 14.97 |
| 2.0 grams | 62.4702 | 62.6190 | 0.1488 | 7.44 |
| 3.0 grams | 68.8260 | 70.0461 | 1.2201 | 40.67 |
| 4.0 grams | 62.2146 | 63.8155 | 1.6009 | 40.02 |
| 5.0 grams | 69.1386 | 69.2959 | 0.1573 | 3.15 |
| 10.0 grams | 62.5678 | 68.4988 | 5.9310 | 59.31 |
| Auto Debris | | | | |
| 0.5 grams | 61.4048 | 61.6116 | 0.2068 | 41.36 |
| 1.0 grams | 61.3027 | 61.3573 | 0.0546 | 5.46 |
| 2.0 grams | 60.9508 | 61.5403 | 0.5895 | 29.48 |
| 3.0 grams | 68.9020 | 68.9854 | 0.0834 | 2.78 |
| 4.0 grams | 61.4075 | 61.3586 | −0.0489 | −1.22 |
| 5.0 grams | 68.7719 | 69.6303 | 0.8584 | 17.17 |
| 10.0 grams | 61.8541 | 65.9458 | 4.0917 | 40.92 |

The FASST Mk II collector had the highest collection efficiency with the collection of Standard Reference Material (SRM) which has a particle size range of 0-40 μm. Over 80 percent of the total SRM sample was collected in the sample collection tube and over 98 percent of the total sample was recovered within the sampler component parts. The collector worked exceptionally well over the entire range of sample SRM sizes from 0.5 g-10 g. The most challenging sample type for the ESP was the auto debris. In this test the sample collection tube caught an average of 19% of the total sample mass, with four of the seven tests having lower than 19% of the total sample captured in the sample collection tube. This behavior is expected, given that auto debris is primarily made up of larger particles (average size=500 μm) that the ESP has been specifically designed to not capture. Collection summaries and representative data from the 5.0 gram collections of each debris type are illustrated in FIGS. 17-20.

### Ultra-Fine Arizona Road Dust: (0-10 μm Particle Size)

Capacity testing of the FASST Mk II collector using the Ultra-Fine Arizona Road Dust (UF-ARD) demonstrated that the device reached its maximum efficiency at 2.0 grams in regards to the percentage of the total sample captured in the sample collection tube. The collection tests at 0.5 grams and 1.0 gram revealed increases in percent of dust collected in the sample tube, while these same tests showed decreases in the percent collected on the Fibertect® filter behind the ESP; however after reaching the peak efficiency, the percent of the total dust sample collected in the sample tube dropped as the percent of the total dust sample collected on the Fibertect® filter increased. Nevertheless it should be noted that the total mass collected in the sample tube rose with the increase in sample size during each subsequent test. Applicant observed no extreme limitations with regards to the maximum amount of sample that could be collected in the collector tube. In six of the seven collection points taken, at least 49% of the total sample was collected in the sample collection tube. Caking action of the UF-ARD was observed to occur on the collection nozzle with an average of 14% of the sample collected on this component part. The sample collection tube and the Fibertect® filter together accounted for more than 80 percent of the total sample collected for each test run with the UF-ARD. Representative data from the 5.0 gram collection of UF-ARD is illustrated in FIG. 17.

Standard Reference Material: (0-40 μm Particle Size)

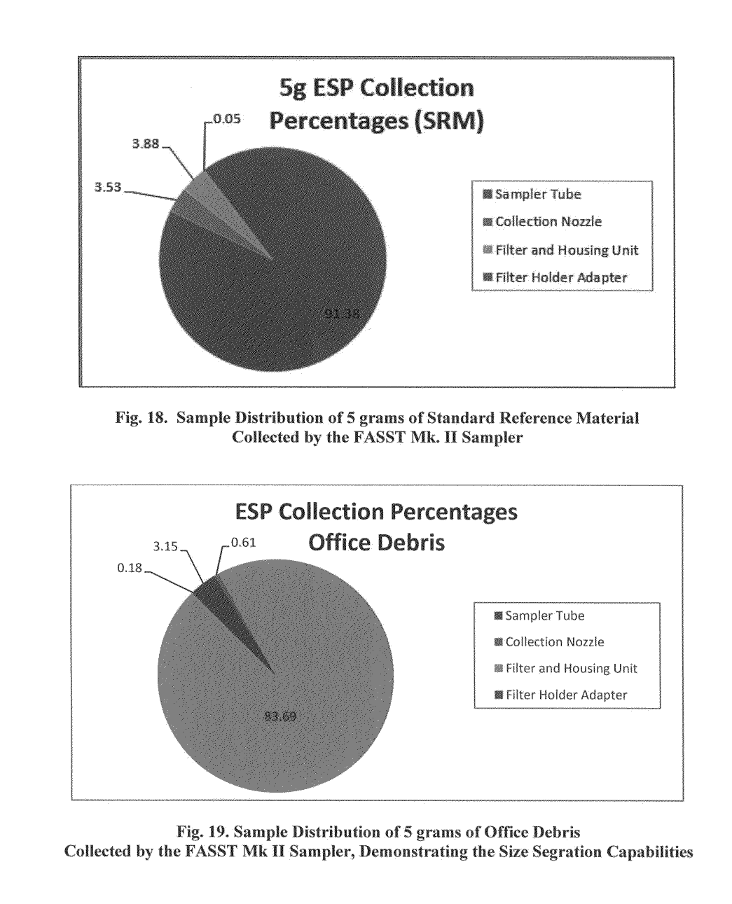

The capacity tests carried out with the ESP using the Standard Reference Material (SRM) demonstrated highly efficient ESP capture. In each test, the FASST MK II prototype recovered over 98 percent of the sample dispersed onto the vacuuming surface. Over 80 percent of that material was collected in the sample collection tube consistently with each increasing sample load. In contrast to the test carried out with the UF-ARD, there was not an observed sample size that demonstrated maximum capacity of the sample collection tube. Instead all collections were consistent and very similar, with the collection tube capturing most of the sample and the filter behind the ESP catching the majority of the rest. Applicant noted no significant sample loss in the collection nozzle or the filter holder adapter, nor did we find any limitations in regards to the amount of sample the ESP tube could collect; as the sample mass increased, so did the sample captured in the collection tube. Representative data from the 5 gram collection of SRM is illustrated in FIG. 18.

Office Debris: (Un-Sieved)

The two previous capacity tests demonstrated that the FASST Mk II collector is highly efficient at collecting when the sample is within the target particle size range. The office and vehicle debris capacity tests demonstrate the size segregation capabilities of the FASST Mk II collector. As discussed earlier, the office debris is a heterogeneous mixture with the percentage of particles in regards to count fewer than 10 μm and the percentage of particles in regards to volume over 500 um. On average, the FASST Mk II system collected approximately 92.3% of the total office-debris sample distributed onto the vacuuming surface during the capacity testing. However, in six out of the seven tests, less than 50% of the total collected sample was retained in the sample collection tube. The rest was caught in large part by the Fibertect® filter at the back end of the ESP device. This is a direct result of the ESP letting the large particles pass on to the filter as it is designed to do. There was not a defined trend in amount of sample collected in the sample collection tube which was inconsistent and ranged from less than 3% for the 5.0 gram sample to 59% for the 10.0 gram sample. At the 3.0 gram test sample loose debris was observed suspended in the filter holder adapter which was lost during disassembly indicating the capacity of the sampler was reached. This observation was consistent as the sample size increased. This is due to the fact that the office debris was made up of much larger particles outside the targeted particle size range of the ESP and is significantly more heterogeneous than SRM or UF-ARD Large particulates were caught in the grates of the collection nozzle which prevented these particulates from entering the device but was uncontained during and after sample collection. A design modification to the collection nozzle may overcome this observed limitation and will be addressed in Phase 3 of the program. Representative data from the 5 gram collection of office debris is illustrated in FIG. 19. The collection percentage of the sampler tube demonstrates the size segregation capabilities of the FASST Mk II system.

Automobile Debris: (<200 mm Particle Size)

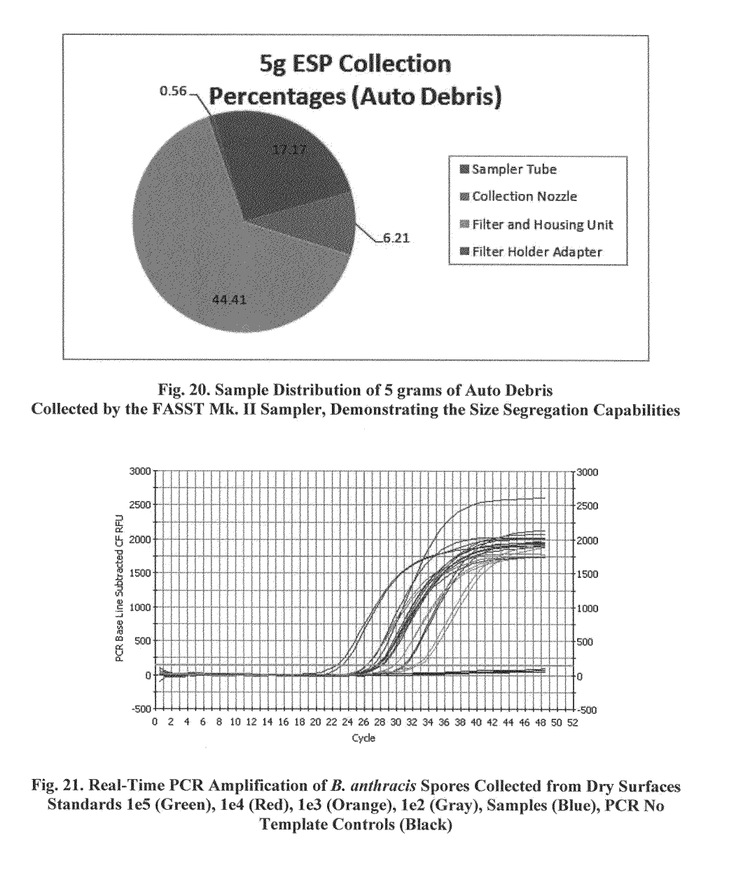

The automobile debris tests were similar to the office debris tests in that a smaller mass percentage of the dispersed sample was collected in the sample tube by the ESP, indicating size segregation. On average, 19% of the sample was collected in the sample tube and 74% was captured by the Fibertect® filter. The majority of the remaining sample was captured by the collection nozzle followed by the filter holder adapter. Similar to the office debris samples there was no distinguishing trend in collection with regards to the amount of material collected in the sample collection tube, due to the highly heterogeneous nature of the debris. The percentage of total mass that was captured in each test seemed to vary by at least an order of magnitude in each subsequent test. Loose debris and loss of sample was also noted as the collector appeared to reach collection capacity with the heterogeneous auto debris sample type at 2.0 grams. Representative data from the 5 gram collection of auto debris is illustrated in FIG. 20.

Fibertect® Filter Vs. 3M™ Filter Evaluation

In each suite of testing with the FASST Mk II collector, Applicant conducted a replicate sample of the 2.0 gram collection of each dust type using the original 3M™ filter to compare against the Fibertect® filter in its DHS custom housing as the downstream filter. The 2.0 gram sample was selected as a moderate sample load to compare the two filter types. The objective was to determine if the substitution of the Fibertect® filter for the 3M™ filter had any impact on sample collection efficiency of the FASST device. Data are compiled in Table 4 below.

TABLE 4
FASST Mk II Sample Recovery with 3M ™ vs Fibertect Filter
For Collection of 2.0 gram Sample of Various Debris

| | | | | | |
|---|---|---|---|---|---|
| | Recovered | Recovered | | | Higher |
| Debris type and | mass (g) with | mass (g) with | | Higher | recovery |
| component | 3M filter | Fibertect filter | % Difference | recovery 3M | Fibertect |

UF-ARD

| | | | | | |
|---|---|---|---|---|---|
| Sample collection tube | 1.009 | 1.514 | 33.4 | | ✓ |
| Collection Nozzle | 0.144 | 0.224 | 35.7 | | ✓ |
| Filter | 0.675 | 0.195 | 71.0 | ✓ | |
| Filter holder adapter | 0.012 | 0.063 | 80.5 | | ✓ |

SRM

| | | | | | |
|---|---|---|---|---|---|
| Sample collection tube | 1.634 | 1.720 | 5.0 | | ✓ |
| Collection Nozzle | 0.002 | 0.125 | 98.7 | | ✓ |
| Filter | 0.359 | 0.143 | 60.2 | ✓ | |
| Filter holder adapter | 0.004 | 0.010 | 65.0 | | ✓ |

Office Debris

| | | | | | |
|---|---|---|---|---|---|
| Sample collection tube | 0.172 | 0.149 | 13.5 | ✓ | |
| Collection Nozzle | 0.000 | 0.004 | 88.9 | | ✓ |
| Filter | 1.689 | 1.653 | 2.2 | ✓ | |
| Filter holder adapter | 0.005 | 0.010 | 45.3 | | ✓ |

Auto Debris

| | | | | | |
|---|---|---|---|---|---|
| Sample collection tube | 0.014 | 0.590 | 97.6 | | ✓ |
| Collection Nozzle | 0.012 | 0.024 | 51.0 | | ✓ |
| Filter | 1.972 | 0.984 | 50.1 | ✓ | |
| Filter holder adapter | 0.002 | 0.020 | 92.0 | | ✓ |

During this limited testing, Applicant noted that there was a relationship between the filter type used as the downstream filter and the efficiency of the sample collection in the sample collection tube. In the cases of the UF-ARD, SRM, and auto debris, the FASST Mk II ESP collector performed better when the Fibertect® filter was downstream instead of the 3M™ filter. There was 33% more UF-ARD, 5% more SRM and 98% more Auto debris collected in the filter collection tube when the Fibertect® filter was downstream of the ESP. In the case of the office debris collection there was 13% more debris recovered in the sample collection tube when the 3M™ filter was used. A more detailed study with increased replicate testing will provide additional data to evaluate the downstream filter component and its potential impact on the collection efficiency of the FASST collector.

### Seeded Dry Surface Collections

The seeded dry surface collections evaluated the FASST Mk II system and the recovery of biological targets suspended in the SRM background for collection from solid surfaces. Stocks of SRM seeded with lyophilized B. anthracis Sterne spores and Vaccinia were prepared as described previously and a 2.0 gram sample was vacuum collected with the FASST Mk II collector. Collected samples were processed for target recovery from the FASST ESP tube (rinsate) and the downstream 3M™ filter and analyzed by real-time PCR and live culture recovery of B. anthracis Sterne. Overall the spore target was readily recovered from the ESP collection tube and the 3M™ filters. Minor variability was noted in target recovery from ESP collection tubes. The standard deviation between replicate collections of B. anthracis spores was 2.2 between ESP collection tubes and 0.1 from 3M™ filters. This variability is expected given the sample-to-sample variation of lyophylized target suspended in sampled aliquots of seeded dust suspended on the solid surface. Results are summarized in Table 5 below and FIG. 21.

TABLE 5
Real-Time PCR Results for
Bacillus anthracis Spores Collected from Dry Surfaces

| SAMPLE | | | MEAN | |
|---|---|---|---|---|
| TYPE | SAMPLE | Ct | Ct | STDEV |
| Controls | Master mix no template control | N/A | NA | |
| | Master mix no template control | N/A | | |
| | Sample add no template control | N/A | NA | |
| | Sample add no template control | N/A | | |
| Samples | RINSATE-1 | 26.9 | 26.5 | 2.2 |
| | RINSATE-1 | 26.2 | | |
| | RINSATE-2 | 30.8 | 30.9 | |
| | RINSATE-2 | 31.0 | | |
| | RINSATE-3 | 28.0 | 28.0 | |
| | RINSATE-3 | 27.9 | | |
| | 3M-1 | 27.5 | 27.4 | 0.11 |
| | 3M-1 | 27.4 | | |
| | 3M-2 | 27.3 | 27.3 | |
| | 3M-2 | 27.3 | | |
| | 3M-3 | 27.4 | 27.5 | |
| | 3M-3 | 27.7 | | |
| Standards | 1E5 BA standard | 23.1 | 22.8 | |
| | 1E5 BA standard | 22.4 | | |
| | 1E4 BA standard | 26.1 | 26.1 | |
| | 1E4 BA standard | 26.1 | | |
| | 1E3 BA standard | 29.6 | 29.6 | |
| | 1E3 BA standard | 29.7 | | |
| | 1E2 BA standard | 32.5 | 32.3 | |
| | 1E2 BA standard | 32.0 | | |

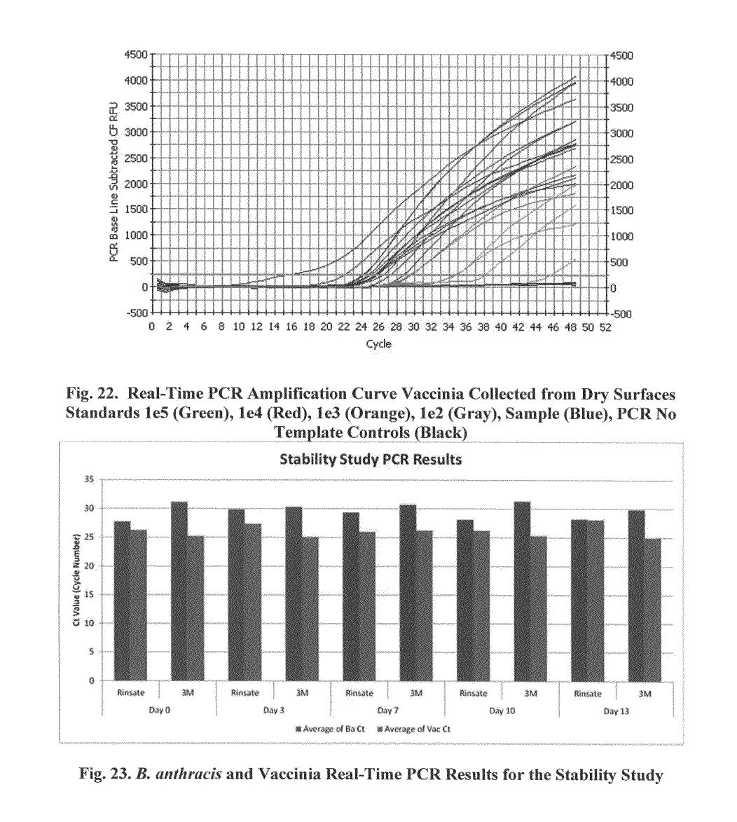

More variability was noted in the Vaccinia collections from dry surfaces particularly on the 3M™ filter. The standard deviation between replicate collections of Vaccinia in the ESP collection tube was 1.6. Higher standard deviation (3.9) was noted for recovery of Vaccinia from the 3M™ filters. Contributing factors to the higher variability of Vaccinia may include the smaller particle size and potential uneven target suspension in the SRM background. The results are detailed in the Table 6 below and FIG. 22.

TABLE 6
Real-Time PCR Results for Vaccinia Collected from Dry Surfaces

| SAMPLE | | | MEAN | |
|---|---|---|---|---|
| TYPE | SAMPLE | Ct | Ct | STDEV |
| Controls | Master mix no template control | N/A | NA | |
| | Master mix no template control | N/A | | |
| | Sample add no template control | N/A | NA | |
| | Sample add no template control | N/A | | |
| Samples | RINSATE-1 | 24.0 | 24.1 | 1.6 |
| | RINSATE-1 | 24.1 | | |
| | RINSATE-2 | 28.7 | 27.0 | |
| | RINSATE-2 | 25.4 | | |
| | RINSATE-3 | 26.4 | 26.8 | |
| | RINSATE-3 | 27.2 | | |
| | 3M-1 | 25.3 | 25.4 | 4.0 |
| | 3M-1 | 25.5 | | |
| | 3M-2 | 25.5 | 25.6 | |
| | 3M-2 | 25.7 | | |
| | 3M-3 | 21.9 | 18.6 | |
| | 3M-3 | 15.3 | | |
| Standards | 1E5 Vac standard | 24.6 | 24.8 | |
| | 1E5 Vac standard | 24.9 | | |
| | 1E4 Vac standard | 29.6 | 29.5 | |
| | 1E4 Vac standard | 29.5 | | |
| | 1E3 Vac standard | 34.7 | 34.6 | |
| | 1E3 Vac standard | 34.4 | | |
| | 1E2 Vac standard | 45.5 | 41.7 | |
| | 1E2 Vac standard | 38.0 | | |

### Stability Study

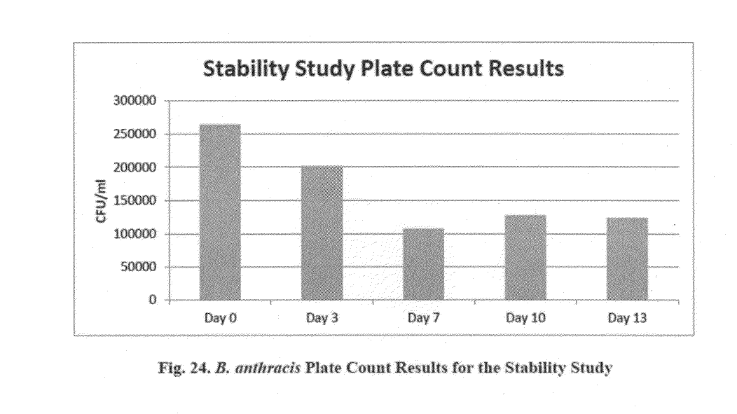

Laboratory stability testing demonstrated two-week stability for recovery of nucleic acid signature from 3M™ filters and ESP collection tubes and viable spores from ESP collection tubes which supports operational field requirements for post-collection sample stability. B. anthracis Sterne colonies were recovered from ESP collection tubes out to 13 days. Full target detection by PCR was demonstrated for both B. anthracis Sterne and Vaccinia up to 13 days when stored at room temperature. Overall target recovery for both B. anthracis and Vaccinia targets was similar from Day zero through Day 13. Although a decline in overall viability was noted, over 1e⁵ CFU/mL of B. anthracis was readily recovered from ESP collection tubes after 13 days of storage. Results are summarized in the Table 7 below and FIGS. 23 and 24.

TABLE 7
B. anthracis and Vaccinia Real-Time PCR Results for the Stability Study

| | | |
|---|---|---|
| | ESP | |
| | rinsate | |
| | Mean | |
| | Ct | 3M Mean |
| Time Point | (n = 4) | Ct (n = 4) |

B. anthracis Recovery

| | | |
|---|---|---|
| Day 0 | 27.73 | 31.15 |
| Day 3 | 29.86 | 30.31 |
| Day 7 | 29.31 | 30.69 |
| Day 10 | 28.12 | 31.29 |
| Day 13 | 28.20 | 29.86 |
| STDEV | 0.90 | 0.59 |
| (Day 0-Day 13) | | |

Vaccinia Recovery

| | | |
|---|---|---|
| Day 0 | 26.25 | 25.24 |
| Day 3 | 27.33 | 25.09 |
| Day 7 | 26.00 | 26.23 |
| Day 10 | 26.23 | 25.32 |
| Day 13 | 28.10 | 24.97 |
| STDEV | 0.90 | 0.50 |
| (Day 0-Day 13) | | |

### Pre-Validation

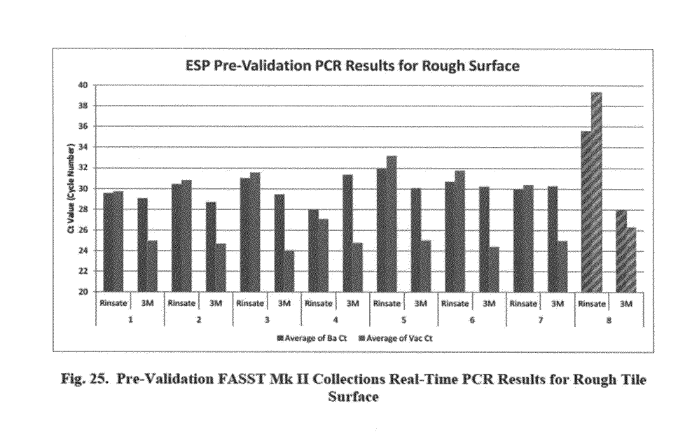

The pre-validation study resulted in PCR detection from all replicate samples collected from rough tile and carpet surfaces. B. anthracis and Vaccinia virus DNA was detected in the ESP rinsate and from the 3M™ portion of all the FASST Mk II collector samples. Replicate samples were collected for the rinsate and 3M™ filter collection system and PCR recovery is presented as an average for each sample and target (FIGS. 25 an 26). Data for Sample 8 is included in the graph although a malfunction occurred during the experiment. Approximately 30 seconds into the collection, the ESP unit shut down and the interlock light turned off. Due to the incomplete collection of SRM, the bar graph for that data point contains hash marks to differentiate the data from the other 7 sample points.

Results indicate that a portion of the targets of interest are passing through the ESP and collected in the 3M™ filter. Target recovery between the rough tile and carpet surfaces were similar but there was a noticeable difference in the data between the two targets when analyzing the ESP rinsate versus 3M™ filter. In several of the Vaccinia samples the Ct, values for the 3M™ filter indicate better recovery of the target when compared to the ESP rinsate. The Ct values for the B. anthracis target are more similar between the rinsate and 3M™ filter with less variability.

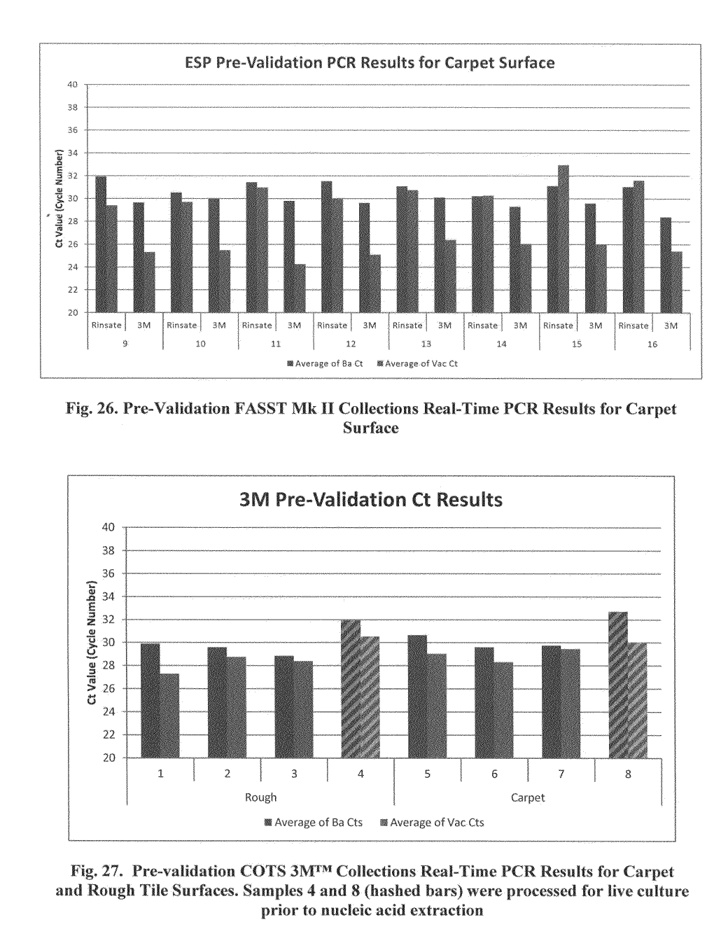

Results from the standard COTS 3M™ collections show nearly equivalent recovery of the spore and virus targets from the filter (See FIG. 27). Sample loss from filters that were pre-processed for live culture lost an average of 2 Cts when compared to filters that were processed only for nucleic acids. When PCR results from the COTS 3M™ (FIG. 27) and the FASST 3M™ filter data (FIGS. 25 and 26) are compared better recovery of the virus target is noted from the FASST Mk II 3M™ filter. An order of magnitude more target of the virus was recovered from the FASST 3M™ filter than from the COTS system 3M™ filter. The spore target was recovered comparably between the two filters.

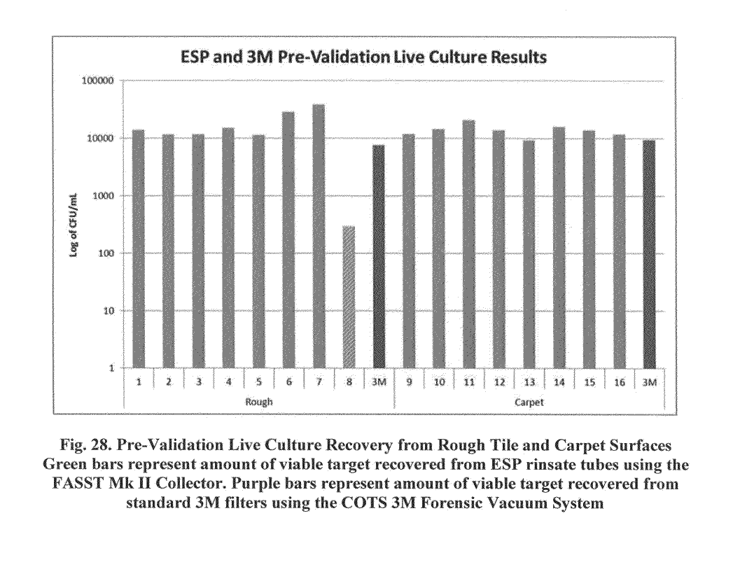

Viable B. anthracis Sterne spores were recovered from all ESP inner tube rinsate samples from rough tile and carpet collections (See FIG. 28). Data for Sample 8 is included in the graph although a malfunction occurred during the experiment which significantly impacted target recovery. The purple bars represent live culture recovery from representative standard 3M™ vacuum collections using a protocol provided by DHS and described earlier. With the exception of sample 8, there was no significant difference in live culture recovery of viable B. anthracis between samples. Comparable recovery of target was achieved using the DHS rinsate protocol from 3M™ filters.

These characteristics are embodied in the FASST Mk II collector with the following benefits:
1. High collection efficiency of particles within the 0-40 μm size range of interest.
2. Segregation of 0-40 μm particles from heterogeneous real world samples.
3. Equivalent spore recovery when compared to the COTS 3M™ system.
4. Enhanced viral recovery when the Mk II collector is coupled with the COTS 3M™ system.
5. Two week room temperature sample stability on the Mk II ESP tube supporting operational requirements.
6. Minimized sample processing time for viable organisms.

Capacity testing of the FASST Mk II collector with a variety of sample types demonstrated high collection efficiency when the sample is within the target particle range and successful size segregation when the sample is of a highly heterogeneous nature. Of the sample types tested, the FASST Mk II collector had the highest collection efficiency with the collection of Standard Reference Material (SRM) which has a particle size range of 0-40 μm. Over 80 percent of the total SRM sample was collected in the sample collection tube and over 98 percent of the total sample was recovered within the MK II component parts. The collector worked exceptionally well over the entire range of sample SRM dust loading quantities from 0.5 g-10 g. The most challenging sample type for the ESP was the auto debris. In this test the sample collection tube caught an average of 19% of the total sample mass, with four of the eight tests having lower than 19% of the total sample captured in the sample collection tube. This behavior is expected, given that auto debris is primarily made up of larger particles (average size=500 □m) that the ESP has been specifically designed to not capture.

The collection nozzle 36 presented a source of sample loss due to caking action of the very fine particulates encountered with Ultra-Fine Arizona Road Dust (1-10 μm) and was also a site of debris clumping in the case of large particles. Large particulates or clumps of gathered debris tended to adhere to the nozzle grating or become matted on the front of the nozzle. A design modification to the collection nozzle to incorporate a coarse filter or internal grating may overcome this limitation.

Pre-validation test results of the FASST Mk II collector demonstrated repeatability and consistency between replicate sample collections as demonstrated by recovery of nucleic acid and viable target. Target recovery from the rough tile and carpet surfaces were consistent between collections. The spore target was recovered from the ESP collection tube and from the downstream 3M™ filters at equivalent levels, although more variability was noted in collections from the rough tile surface. Live culture data for B. anthracis was relatively consistent between sample collections and comparable to the current DHS live culture recovery from 3M™ filters. The virus target was consistently recovered to a higher degree from the downstream filter than from the ESP sample collection tube. Significantly more virus (by an order of magnitude) was recovered from the FASST 3M™ filter than from the COTS 3M™ filter and when combined with target recovered from the ESP collection tube, the FASST Mk II collector provides significantly more target for analysis from its component collection tube and 3M™ filter components.

The primary benefit of the FASST collector is its ability to efficiently collect small particles within the size range of biological organisms for rapid recovery in a pre-coated collection vessel designed to stabilize collected organisms and promote rapid live culture recovery. Laboratory stability testing demonstrated two-week stability of vacuum collected samples held at room temperature for recovery of nucleic acid signature and spores from the ESP tube which supports operational field requirements for post-collection sample stability. The FASST collection system provides end users with a unique collection system which greatly diminishes sample processing time particularly for viable organisms. The ability to expand in culture biological agents collected from a crime scene provides the opportunity to gather detailed microbiological analysis including biochemical analysis, serotyping, virulence determination, antibiotic susceptibility in additional to sequencing and genotyping data, critical data points to determine source attribution.

Overall, the FASST Mk II collector met the objectives of the second phase of the program, but laboratory testing and client feedback revealed key areas for improvement during Phase III of the FASST program. First, Applicant will refine the FASST Mk II collector by adding sample containment and extraction features that prevent the inadvertent release of captured biological particles during extraction and analysis. This will be accomplished by adding collection tube sample containment caps such as caps 42 and 44 (FIG. 12) with injection/extraction ports. The user will install these caps in the field after the collection tube is removed. This feature will effectively eliminate potential re-aerosolization and exposure of captured sample to test facilities during the extraction and recovery process. Applicant will also improve the front end filter on the FASST Mk II collector. The purpose of this filter is to eliminate large material such as hairs and fibers from entering into the collection tube, reducing the concern of arcing and clogging within the ESP. However, testing of the FASST Mk II collector showed that this front end filter can itself become clogged, reducing airflow through the device. This debris is then difficult to recover for subsequent analysis. This front end filter will be redesigned in Phase III to eliminate these issues. Finally, minor changes to the electronics and user interface will be made to improve safety and ease of use.

### FASST Mk III Design

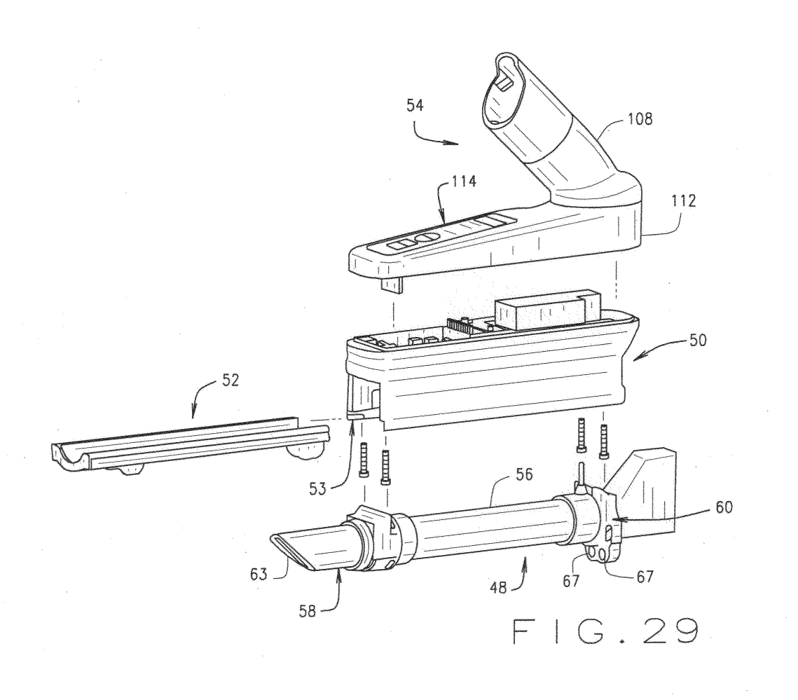

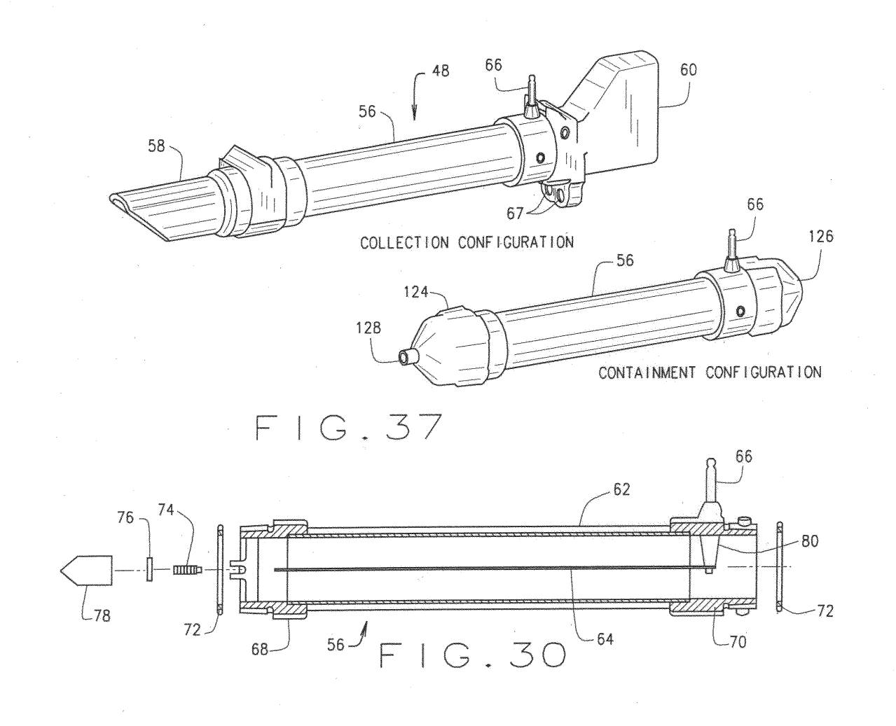

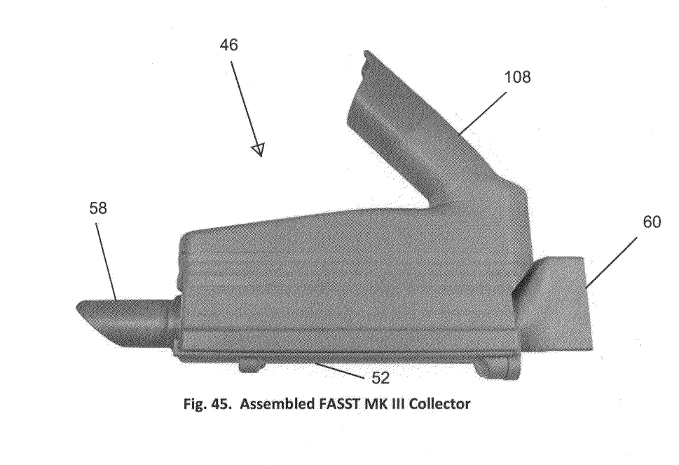

The FASST MK III collector 46 is more clearly identified in FIGS. 29-50, this embodiment being constructed according to the teachings of the present invention. FIG. 29 represents an exploded view of the FASST MK III collector 46 which includes a collection tube system 48, a center case assembly 50, a bottom sliding cover 52 and a handle assembly 54. The collection tube assembly includes a tube module 56, an intake nozzle 58 and a filter adapter 60. An exploded cross-sectional view of the collector tube module 56 is best illustrated in FIG. 30 and includes the collector tube 62, the high voltage wire electrode 64, a high voltage electrode 66 for insertion into a corresponding receptacle associated with the electronics housing, a front adapter 68 and a rear adapter 70. The high voltage electrode 66 is associated with the rear adapter 70. The collection tube 56 also includes a pair of silicon O-rings 72 as illustrated in FIG. 30, a tension spring 74, a spring pin 76 and a spring cover 78. The high voltage wire electrode 64 is appropriately suspended within the collector tube 62 between the rear bracket member 80 and the front tension spring 74. The wire 64 extends through the front adapter 68 and attaches to the tension spring 74.

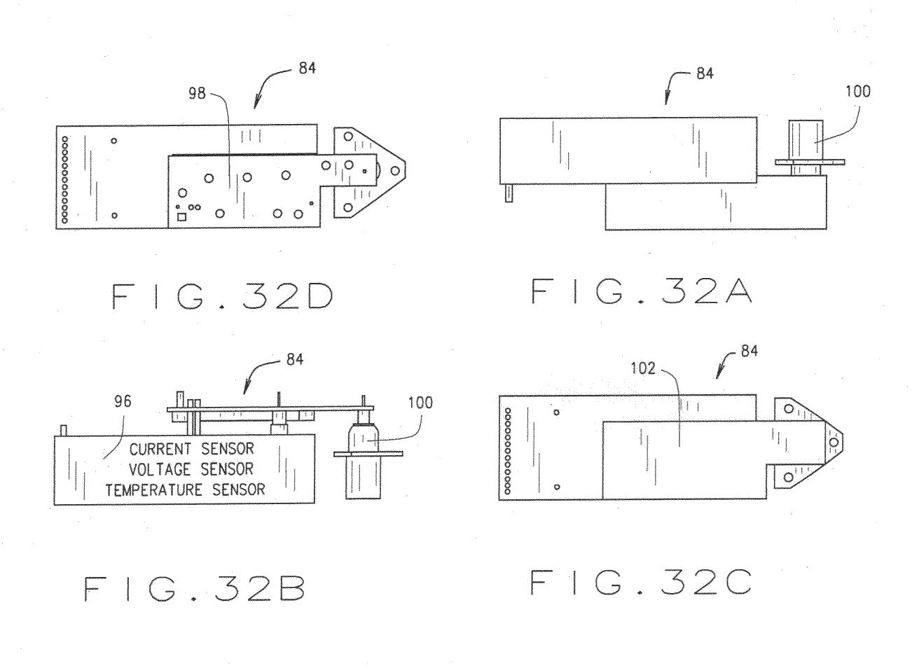

The core technology in the FASST MK III collector 46 is the electrostatic precipitator (ESP) that employs a high voltage power supply 84 (FIGS. 32A-D) associated with the electronics package as will be hereinafter further explained which provides approximately 10,000 volts dc to the wire electrode 64 suspended within the collection tube. This configuration generates a corona discharge to ionize the sample air stream and create free electrons. Smaller (1-20 μm) particles entering the ESP collector tube module 56 encounter the ionization field, causing them to efficiently precipitate onto the collection tube wall 62. Due to their inertia, larger particles pass through the ionization field and are captured by a secondary dry filter located downstream of the ESP. The 3M™ vacuum as previously explained with respect to the FASST MK II collector discussed above is the primary air mover for the FASST MK III collector as well.

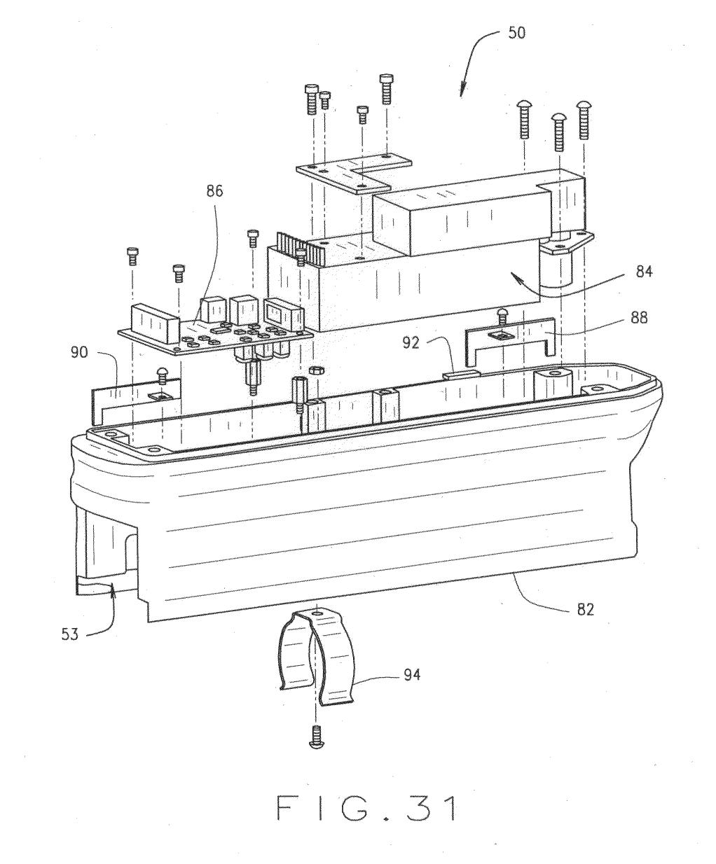

An exploded view of the center case assembly 50 is best illustrated in FIG. 31 and includes a center case housing 82, a high voltage supply assembly 84, a main electronics PC board including a microprocessor 86, a rear Hall Effect PC board sensor 88, a front Hall Effect PC board sensor 90 and a bottom Hall Effect PC board sensor 92. The sensors 88, 90 and 92 are part of a safety mechanism or sensor system that protects the overall MK III collector 46 and the operator from damage and injury due to high voltage exposure as will be hereinafter further explained. The center case assembly 50 likewise includes a spring clip 94 positioned therewithin for engaging the collector tube assembly 48 when the assembly 48 is positioned within the center case assembly 50.

FIGS. 32A, 32B, 32C and 32D illustrate top and side elevational views of the high voltage supply assembly 84 located within the center case assembly 50. The high voltage supply assembly 84 includes a high voltage power supply 96 (FIG. 32B), a high voltage PC board 98 (FIG. 32D), a high voltage connector 100 (FIGS. 32A and 32B), and a high voltage potting case 102 (FIG. 32C). The high voltage supply assembly 84 provides the required DC volts to the wire electrode 64 for generating the corona discharge within the collector tube 62 to ionize the incoming sample air stream. The high voltage supply assembly 84 is located within the center case assembly 50 as best illustrated in FIG. 31.

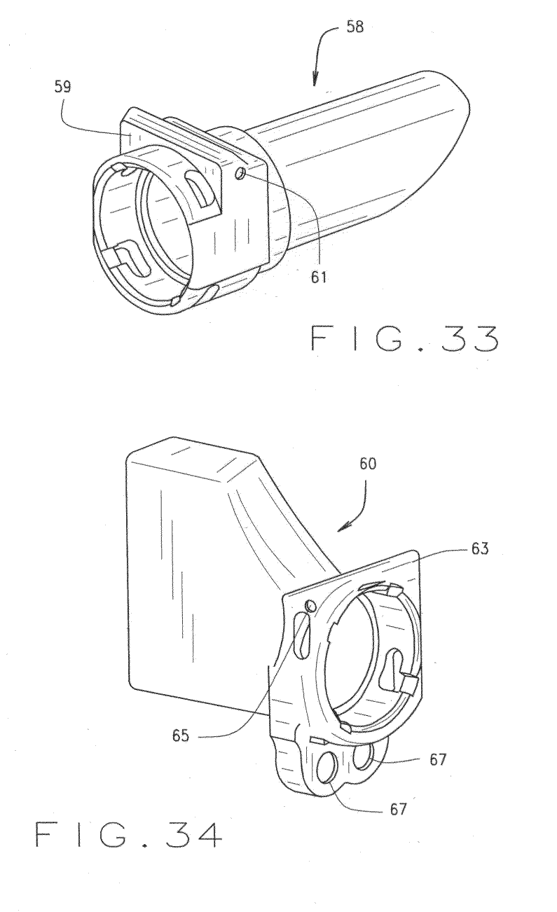

FIG. 33 is a perspective view of the intake nozzle 58 associated with the collection tube assembly 48 illustrated in FIG. 29. The intake nozzle 58 includes an attachment portion 59 for cooperatively attaching to the front adapter portion 68 associated with collection tube module 56. Any suitable cooperatively engageable means associated with both members 59 and 68 can be utilized to suitably engage the intake nozzle 58 to the front portion of the collector tube module 56. As illustrated in FIG. 33, the cooperatively engageable means could be corresponding threads, a snap-fit arrangement, or a quarter-turn lock arrangement. The adapter portion 59 likewise includes a magnet 61 as best illustrated in FIG. 33. The front Hall Effect sensor 90 associated with the center case assembly 50 senses magnet 61 when the collector tube assembly 48 is properly positioned within the center case assembly 50 as will be hereinafter further explained. The intake nozzle 58 likewise includes a front-end screen/filter member 63 as best illustrated in FIG. 29 that functions to eliminate large material such as hairs and fibers from entering into the collection tube 62 thereby reducing the concern of arcing and clogging within the ESP.

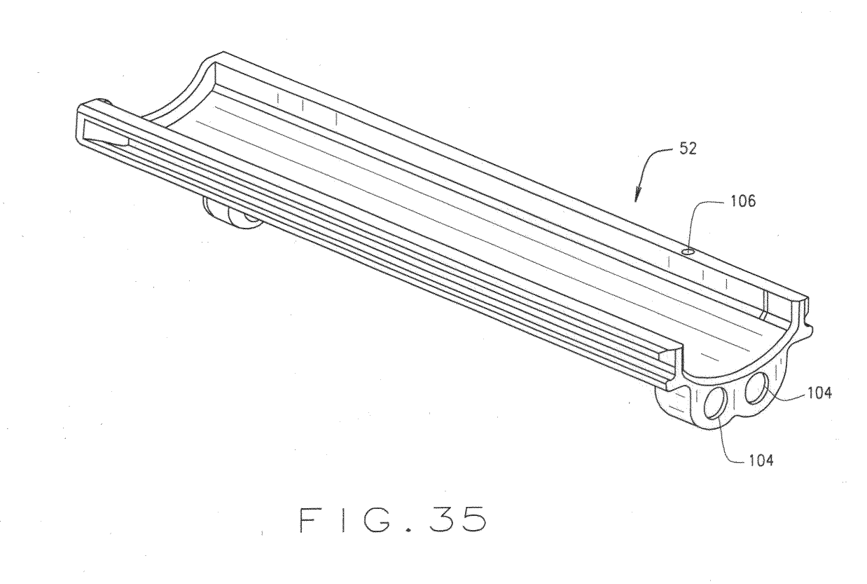

FIG. 34 is a perspective view of the filter adapter 60 associated with the collection tube assembly 48 illustrated in FIG. 29. The filter adapter 60 likewise includes an attachment portion 63 having cooperatively engageable means associated therewith for attaching to the rear adapter portion 70 associated with collection tube module 56. Here again, any suitable type of cooperating means for attaching filter adapter 60 to member 70 associated with the collection tube module 56 can be utilized such as cooperating threads, a snap-fit, or a quarter-turn locking mechanism. The filter adapter 60 likewise includes a magnet 65 which is sensed by the rear Hall Effect sensor 88 associated with the sensor case assembly 50 when the rear portion of the collector tube assembly 48 is properly installed within the center case assembly 50 as will be hereinafter further explained. The attachment portion 63 of filter adapter 60 likewise includes a pair of magnet latches 67 which will mate and lock with a corresponding pair of magnet latches 104 associated with the bottom sliding cover 52 which is best illustrated in FIG. 35. The magnet latches 104 associated with the bottom sliding cover 52 will mate with and engage the magnet latches 67 associated with the filter adapter 60 when the collection tube assembly 48 is properly positioned within the center case assembly 50 and when the bottom sliding cover 52 is properly engaged with the track mechanism associated with the bottom portion of center case assembly 50. The bottom sliding cover 52 likewise includes a magnet 106 which is likewise sensed by the bottom Hall Effect sensor 92 associated with the center case assembly when the bottom sliding cover 52 is properly engaged and installed within the center case assembly 50. The magnets 61, 65 and 106 likewise form part of the safety mechanism or sensor system which protects the overall collector 46 and the operator from damage and injury due to high voltage exposure as will be hereinafter further explained.

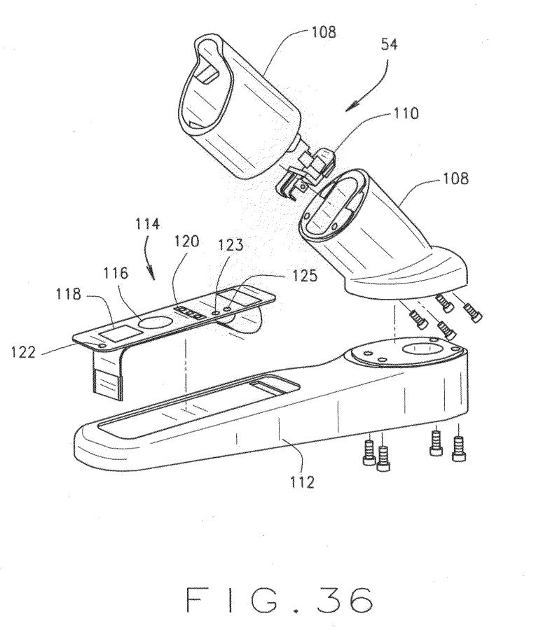

FIG. 36 is an exploded perspective view of the handle assembly 54 illustrated in FIG. 29. The handle assembly 54 includes a handle member 108, a battery clip holder 110, a base member 112 and a user interface 114. The FASST MK III collector 46 is powered by at least one off-the-shelf 12-volt lithium-ion battery enabling operation for up to at least 2 hours. The handle mounted battery (not shown) snaps in and out of the battery clip 110 for easy recharging or replacement. Replacement batteries are available at home improvement stores nationwide. LED indicators, status lights, power buttons and so forth are integrated into the single membrane user interface 114 as will be hereinafter further explained. The interface 114 includes an on-off button 116, a COLLECT enable button 118, a series of battery life status LEDs 120 and three LEDs 122, 123 and 125 indicating operational status. LED 122 is a collection status light and LEDs 123 and 125 are system error status lights as will be hereinafter further explained. When the handle assembly 54 is properly engaged with the center case assembly 50, electrical contact with all of the electrical components associated with the FASST MK III collector 46 will be electrically coupled for operational use.

The Hall Effect sensors 88, 90 and 92 in conjunction with magnets 61, 67 and 106 provide several safety mechanisms or sensor systems that protect the unit and operator from damage and injury due to high voltage exposure. The FASST Mk III collector will not enable high voltage unless it is fully and properly assembled. There are three safety interlocks that will prevent high voltage from turning on if the full collection tube assembly 48 and bottom sliding door cover 52 are not fully and properly installed. Additionally, if either of these two components are removed from the unit during operation or become dislodged from their properly installed position, high voltage will immediately be disabled. The safety interlocks are in effect Hall Effect (magnetic) sensors 88, 90 and 92 that signal or communicate with the micro-processor when an ESP tube assembly 48 is properly installed and the safety cover or access door 52 is closed. As previously discussed, the Hall Effect sensors 88, 90 and 92 sense the proper position of the respective magnets 61, 65 and 106 associated with the intake nozzle 58, the filter adapter 60 and the bottom sliding door cover 52 when all of these components are in their proper installed position. If any one of these components is not properly installed, the appropriate Hall magnet sensor system will not read its associated magnet and therefore will prevent high voltage from turning on, or it will disable high voltage if the collection process has already started. The respective magnets 61, 65 and 106 are positioned and located such that the respective Hall Effect sensors 88, 90 and 92 will be able to read and sense the magnet when its corresponding component is properly installed and positioned within the center case assembly 50. In other words, the sensors 88, 90 ad 92 sense the proper position of the intake nozzle 58, the filter adapter 60 and the access door 52 within the center case or housing assembly 50 and communicate with the microprocessor 86 to prevent high voltage from being supplied to the electrode wire 64 if any of these components are not properly installed or positioned within the housing assembly 50. This safety mechanism is indicated by the yellow safety LED 125 and red system LED 123 as will be hereinafter further explained. Under normal conditions, the yellow safety LED 125 and red high voltage (HV) error LED 123 are off. It will blink in different patterns if any component is missing from the unit as explained below. The switches are hidden from the user's sight within the electronics enclosure 50 to reduce the likelihood of a user circumventing the safety interlocks.

The electronics and microprocessor 86 in the Mk III collector 46 receive feedback from the internal high voltage power supply 84. Excessive current draw, under voltage, and excessive power supply temperature are all monitored by appropriate sensors and can be signs of a possible electrical short or other malfunction. For example, the high voltage power supply 96 includes (1) a current sensor for monitoring excessive current draw from the high voltage power supply assembly 84; (2) a voltage sensor for monitoring under voltage from the high voltage power supply assembly 84; and (3) a temperature sensor for monitoring excessive temperature of the high voltage power supply 96. The high voltage power supply 96 will be shut down if any of these scenarios are detected. This will be indicated by blinking operational status LEDs 123 and 125 as will be hereinafter further explained.

When the 12 volt battery is installed, the operator will press and hold the ON/OFF button 116 for three seconds to power on the unit. After three seconds, all three battery life status LEDs 120 will turn on steady, while the three operational status LEDs 122, 123 and 125 will blink, simultaneously for 5 seconds, indicating the power on sequence. Once the blinking stops, the green battery life status LEDs 120 (either one, two, or all three, depending on available battery life) will remain on constant. To enable collection, the operator will press and hold the COLLECT button 118 for three seconds. The collection status LED 122 will then remain on steady as long as high voltage is being supplied to the FASST Mark III's electrostatic precipitator and the unit is functioning properly. There are two options to disable collection. The first option is to press the collect button 118. The collection status LED 122 will then turn off. The second option is to press the on/off button 116 which will disable collection and power off the entire unit.

The FASST Mark III has three battery life status LEDs as seen in FIG. 36. These LEDs are used to indicate available battery life and provide a warning as to when the FASST Mark III collector will automatically shut down due to low available battery power. Table 8 shows which LEDs will display at different battery voltage ranges. As the FASST Mark III battery life drops below 9.8V, the last LED will blink very rapidly for five seconds before the unit powers down.

TABLE 8
Battery Life LED Status

| LEFT | MIDDLE | | |
|---|---|---|---|
| LED | LED | RIGHT LED | DESCRIPTION |
| OFF | OFF | OFF | POWER OFF |
| BLINKING | OFF | OFF | BATTERY VOLTAGE >9.8 V |
| | | | AND <10.3 V |
| ON | OFF | OFF | BATTERY VOLTAGE >10.3 V |
| | | | AND <10.8 V |
| ON | ON | OFF | BATTERY VOLTAGE >10.8 V |
| | | | AND <11.3 V |
| ON | ON | ON | BATTERY VOLTAGE >11.3 V |

The three Hall Effect safety mechanisms (88, 90, 92, 61, 67 and 106) discussed above will protect the unit from damage and the operator from injury due to high voltage. The Mark III collector will not enable high voltage unless it is fully assembled as discussed above. Additionally, if any of these components are removed from the unit during operation, or become dislodged from their properly installed position, high voltage will be immediately disabled. This safety mechanism is indicated by the yellow SAFETY ERROR LED 125. Under normal conditions, the yellow LED 125 and red LED 123 are off. They will blink in different patterns if any component is missing from the unit. If the yellow LED 125 and/or red LED 123 are blinking, the user needs to ensure that all the components of the FASST Mark III collector are fully assembled. The electronics in the Mark III collector receive feedback from the internal high voltage power supply 96. As previously explained, excessive current draw, under voltage, and high voltage power supply temperature are all monitored by various sensors or other systems and these sensors communicate with the microprocessor to shut down the high voltage power supply 96 if any of these scenarios are detected. This will be indicated by a blinking red HV ERROR LED 123 for an excessive current draw or under voltage and a blinking red HV ERROR LED 123 and steady on yellow LED 125 for an overheating scenario. Table 9 below shows all possible LED status scenarios for the FASST Mark III collector.

TABLE 9
LED Status Indicator Table

| | | COLLECTING | |
|---|---|---|---|
| SAFETY ERROR | HV ERROR | (AMBER | |
| (YELLOW LED) | (RED LED) | LED) | DESCRIPTION |
| OFF | OFF | ON | COLLECTING WITH NO ERRORS |
| OFF | OFF | OFF | POWERED OFF |
| BLINK SLOW | BLINK | BLINK SLOW | POWER UP SEQUENCE |
| | SLOW | | |
| BLINK SLOW | OFF | OFF | DOOR OPEN |
| BLINK FAST | OFF | OFF | INTAKE NOZZLE OUT OF |
| | | | POSITION |
| BLINK FAST | ON | OFF | FILTER ADAPTOR OUT OF |
| | | | POSITION |
| OFF | BLINK | OFF | HV CURRENT ERROR |
| | SLOW | | |
| OFF | BLINK FAST | OFF | HV VOLTAGE ERROR |
| ON | BLINK | OFF | HV OVER TEMP |
| | SLOW | | |

Removing the collection tube assembly 48 for analysis takes less than 20 seconds and is a tool-free process. Sample recovery protocols have been developed to efficiently remove viable biological agents and nucleic acids from the collector's coated (trehalose/betaine) surface 62 to enable live culture and molecular analysis of sample extracts recovered from the system. The FASST MK III device contains sample containment and extraction features that prevent the inadvertent release of captured biological particles during extraction and analysis via collection tube sample containment caps 124 and 126 with injection/extraction ports as best illustrated in FIG. 37. The end-user installs these caps in the field after the collection tube is removed.

FIG. 37 is a perspective view of the collector tube module 56 in both its collection configuration and its containment configuration. The collection configuration is likewise illustrated in FIG. 29 and is the collection tube assembly 48. As indicated above, once collection is complete, the end-user or operator will remove the collection tube assembly 48 from the center case assembly 50 by opening the bottom sliding access door cover 52 and removing the collection tube assembly 48 therefrom. Once the collection tube assembly 48 is removed from the overall device, the inlet nozzle 58 is removed and replaced with containment cap 124 and the filter adapter 60 is removed and replaced with containment cap 126. Containment cap 124 likewise includes an injection/extraction port 128 wherein a buffer solution can be injected into the collection tube 56 to help preserve the biological material collected therein. Removal or extraction of the biological material collected within the collection tube 56 is likewise extracted through the same injection port 128. This feature effectively eliminates potential re-aerosolization and exposure of captured sample to test facilities during the extraction and recovery process. In addition, the collector tube assembly 48 includes a front end screen 63 that functions to eliminate large material such as hairs and fibers from entering into the collection tube, again reducing the concern of arcing and clogging within the ESP.

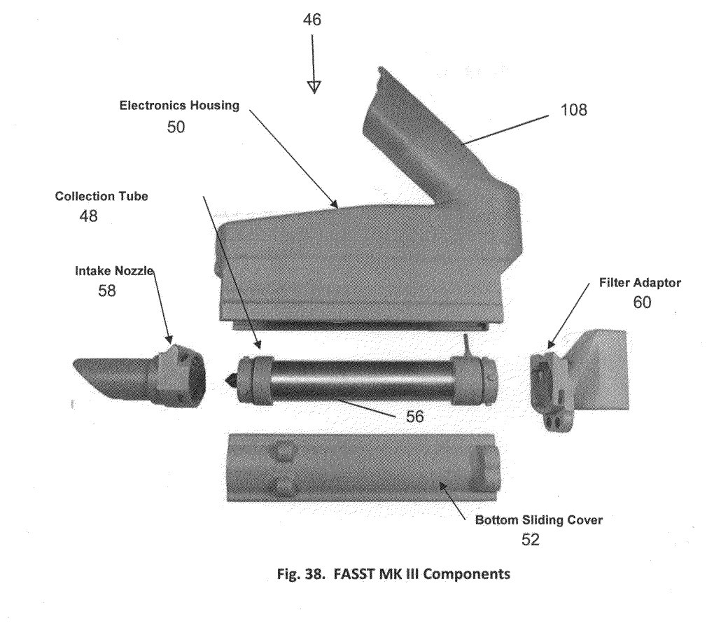

Assembly of both the collection tube assembly 48 and the entire FASST MK III collector 46 is set forth below and illustrated in FIGS. 38-50. The step-by-step attachment process as well as use of the MK III collector 46 is as follows.

### Collection Tube Assembly

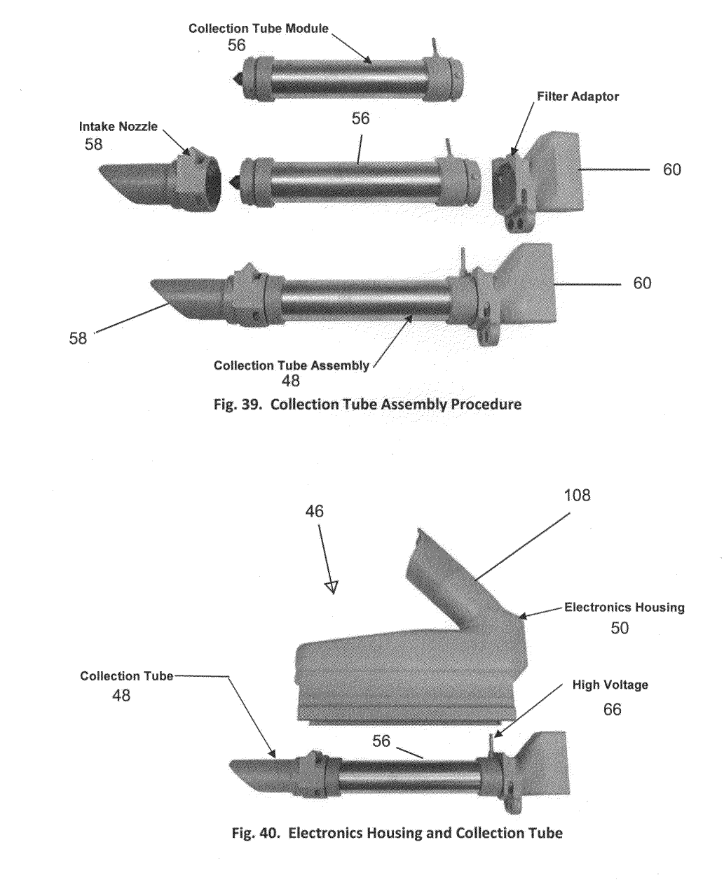

1. Attach the intake nozzle 58 and the filter adapter 60 to the collection tube module 56. See FIGS. 38 and 39.

### FASST Mark III Unit Assembly

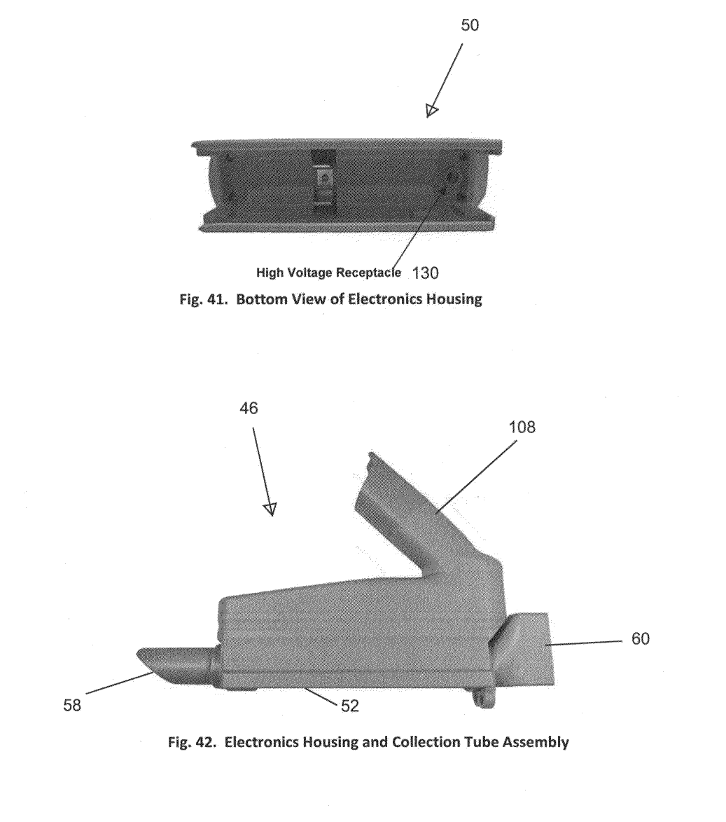

1. Insert the Collection Tube Assembly 48 into the Electronics Housing or center case assembly 50. Ensure that the high voltage electrode 66 (FIG. 40) on the Collection Tube Assembly 48 is inserted into the high voltage receptacle 130 (FIG. 41) on the Electronics Housing/center case assembly 50. See FIG. 42 for complete assembly of collection tube assembly 48 and its housing 50.

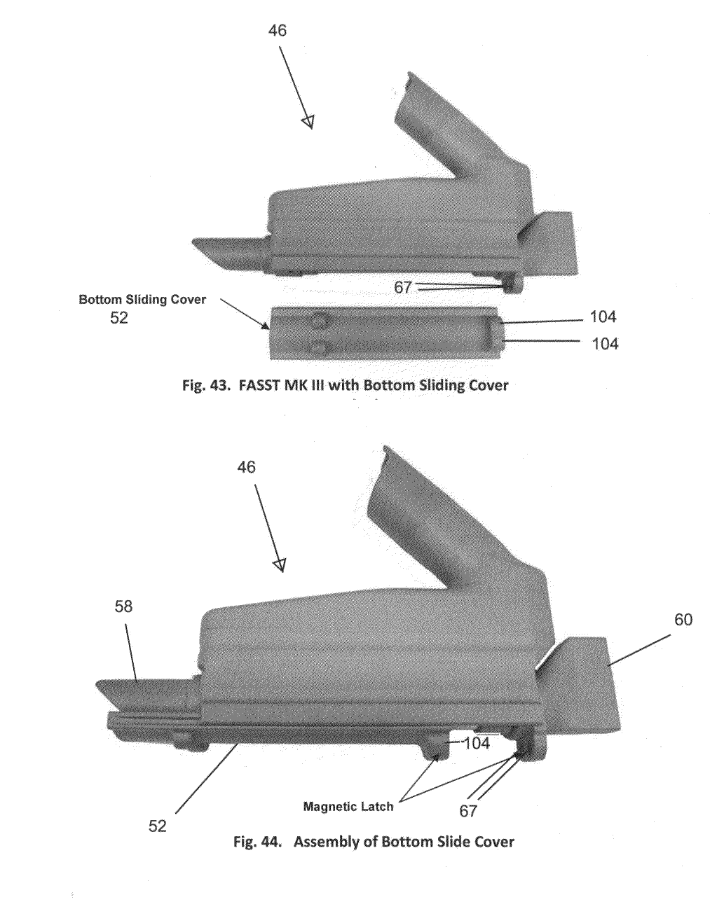

2. Attach the bottom sliding access cover 52, which is secured in place by a magnetic latch 67, 104 (FIGS. 43, 44 and 45).

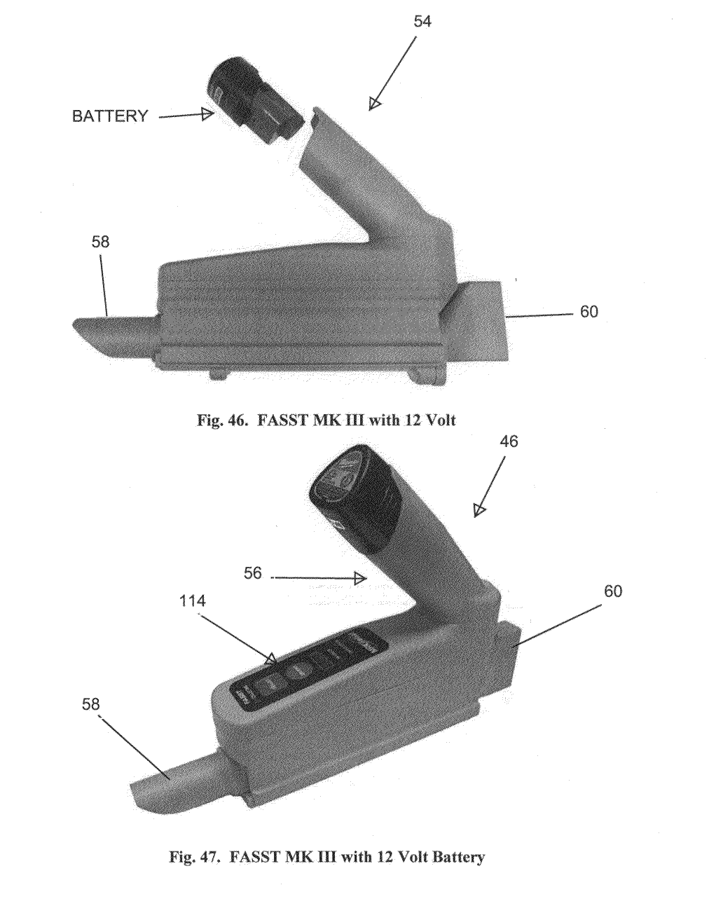

3. Plug the 12 volt battery in the FASST Mark III collector 46 (FIGS. 46 and 47).

### Full System Assembly

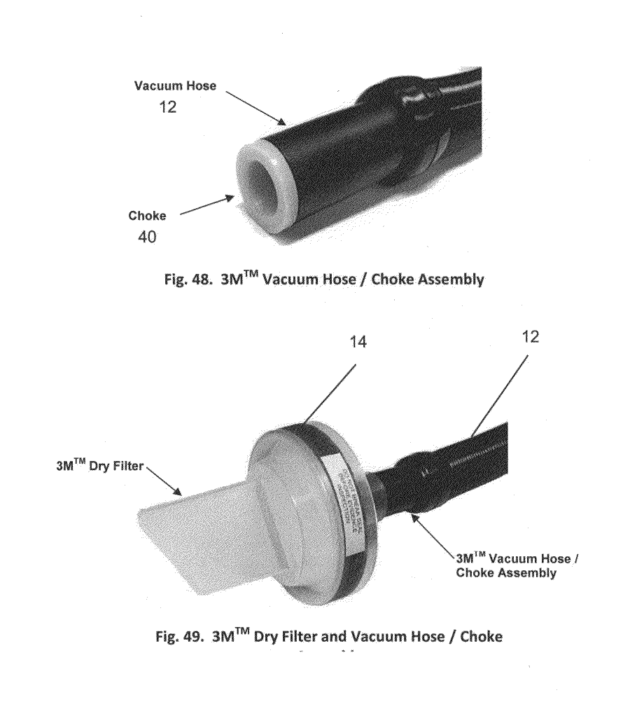

1. Slide the 3M™ vacuum choke 40 into the end of the 3M™ trace Evidence Vacuum hose 12 (FIG. 48).

2. Attach the 3M™ Dry Filter 14 to the 3M™ Trace Evidence Vacuum Hose/Choke Assembly (FIG. 49).

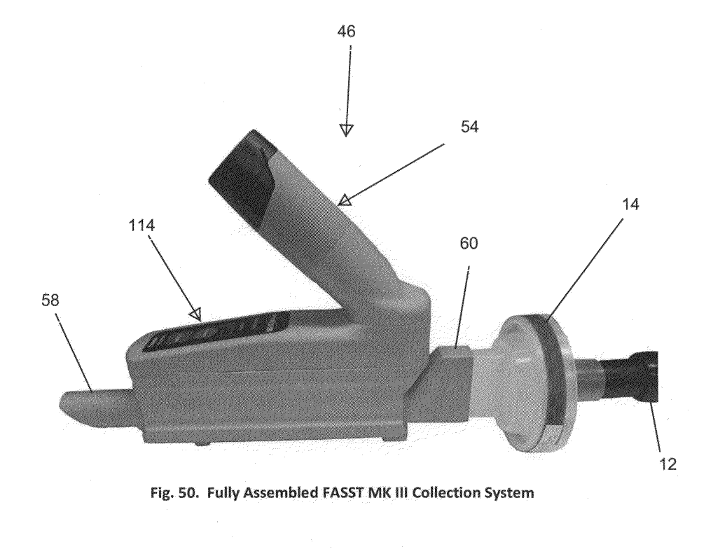

3. Attached the complete hose assembly to the FASST Mark III collector (FIG. 50).

### how to Successfully Use the System

1. When the 12 volt battery is installed, press and hold the ON/OFF button 116 for three seconds to power on the unit. After three seconds, all three battery life status LEDs 120 will turn on steady, while the three operational status LEDs 122, 123 and 125 will blink simultaneously for 5 seconds, indicating the power on sequence. Once the blinking stops, the green battery life status LEDs 120 (either one, two, or all three, depending on available battery life) will remain on constant. To enable collection, press and hold the COLLECT button 118 for three seconds. The collection status LED 122 will remain on steady as long as high voltage is being supplied to the FASST Mark III's electrostatic precipitator and the unit is functioning properly.

2. There are two options to disable collection. The first is to press the COLLECT button 118. The collection status LED 122 will turn off. The second is the press the ON/OFF button 116, which will disable collection and power off the unit.

3. After collection, disassemble the unit in reverse order as discussed during assembly above. Remove the collection tube assembly 48, remove the inlet nozzle 53 and cap with the front containment cap 124; remove the rear filter adapter 60 and cap with the rear containment cap 126.

4. Add 6-mL of PBS to the collection tube 56 via injection port 128.

5. Vortex and extract PBS buffer via the same injection port 128.

6. The sample is now ready for biological analysis via live culture/PCR.

### Tube Coating Long Term Stability Study

The tube coating, like any other organic or chemical substance, can undergo chemical changes (e.g. degradation, oxidation), and/or physical changes (e.g. delamination, flaking, crystallization) over time. The stability study identified how those changes altered the efficacy of the formulated coating solution and the timeframe associated with those changes. Another study goal was to identify the time duration at which the tube can no longer be used when stored at two specific temperature conditions.

Applicant cleaned fifty-eight (58) 6061 Aluminum (Al) tubes to evaluate the stability of the coating. Fifty new Al tubes were cleaned with the modified cleaning SOP presented below and were used for the first 5 time points. These Al tubes were purchased on Phase II of this program and had not been coated prior to this study. The remaining eight (8) tubes were Phase I Al tubes cleaned and re-coated for the last time point. Applicant prepared a fresh trehalose/betaine solution prior to cleaning the Al tubes. Initially, staff followed the draft SOP developed under Phase I of the FASST program to clean the tubes. However, once issues were noted with coating the new 6061 Al material, the draft SOP was slightly modified to the procedure outlined below:

1. Prepare an aqueous solution of D-Greeze AC Z603 (Solvent Kleene); one (1) part AC Z603 to five (5) parts distilled water

2. Place 6061 aluminum alloy tubes, on end, in 2 L glass beaker

3. Cover aluminum tubes with the diluted D-Greeze solution

4. Place 2 L glass beaker in ultrasonic bath

5. Ultrasonicate aluminum tubes for 30 minutes

6. Remove aluminum tubes, rinse with distilled water, and place on clean kimwipe

7. Place 6061 aluminum alloy tubes, on end, in 2 L glass beaker

8. Cover aluminum tubes with methanol

9. Place 2 L glass beaker in ultrasonic bath

10. Ultrasonicate aluminum tubes for 30 minutes

11. Remove aluminum tubes and place on clean kimwipe

12. Place aluminum tubes, on end, in 2 L glass beaker

13. Cover aluminum tubes with acetone

14. Place 2 L glass beaker in ultrasonic bath

15. Ultrasonicate aluminum tubes for 30 minutes

16. Remove aluminum tubes and place on clean kimwipe

17. Allow tubes to air dry 5 minutes

18. Rinse tubes with water to remove residual acetone and physical debris

19. Place cleaned aluminum tubes in plastic zip-loc bags

Applicant then followed the draft SOP developed under Phase I of the FASST program to coat the tubes. The coating steps are provided in brief below:

1. Turn heated roller equipment on and verify that the rollers are rotating and heating

2. Turn heated roller equipment to 125° C. setting

3. Verify temperature was at least 50° C.

4. Turn on heat gun to high setting and aim just above heated rollers

5. Place black plastic caps onto both ends of 12 clean aluminum tubes

6. Use Eppendorf pipettor to place 7 mL trehalose/betaine (aq) solution into each aluminum tube (two additions of 3.5 mL each)

7. Roll aluminum tube slowly multiple turns to ensure the coating solution properly wetted the entire inner aluminum diameter

8. Visually verify that all interior surfaces were wetted and retained wetness

9. Place 12 aluminum tubes containing coating solution onto the heated roller equipment

10. Heat aluminum tubes for 2.5 hours

11. Remove aluminum tubes from heat

12. Verify visually that internal aluminum surfaces were completely coated (Note: 6061 Al alloy uncoated sections will appear gold)

13. Place fully coated aluminum tubes in plastic zip-loc bag

14. Place one dessicator package into plastic zip-loc bag

15. Place one humidity indicator card into plastic zip-loc bag

16. Remove air from zip-loc bag with vacuum

17. Seal zip-loc bag and placed in dry storage

Table 10 summarizes the test matrix used to evaluate the coating stability. Two environmental conditions (5° C. and 30° C.) were created for each of the six (6) time points (1-24 weeks), with the first five (5) time points having five (5) replicate tubes to evaluate. Applicant evaluated only four (4) replicate tubes at the 24-week time point due to complications with initially coating the raw Al material. Eight (8) spare Al tubes used in Phase I were cleaned and re-coated to reduce the schedule delay caused by modifying the tube cleaning SOP.

TABLE 10
Sample Matrix for Stability Study

| | Parameter | | |
|---|---|---|---|
| # of Samples | Time Point | Humidity | Temperature |
| 5 | 1-week | <5% | 5° C. |
| 5 | | | 30° C. |
| 5 | 2-week | <5% | 5° C. |
| 5 | | | 30° C. |
| 5 | 4-week | <5% | 5° C. |
| 5 | | | 30° C. |
| 5 | 8-week | <5% | 5° C. |
| 5 | | | 30° C. |
| 5 | 16-week | <5% | 5° C. |
| 5 | | | 30° C. |
| 4 | 24-week | <5% | 5° C. |
| 4 | | | 30° C. |

| | |
|---|---|
| 58 | Total Number of Samples |

At each time point, tubes were removed from the environmental chamber and inspected. The coating mass was determined by weighing the coated tube after storage and subtracting the uncoated Al 6061 tube mass. Differences in coating weights are due to water absorption, slight coating solution volume differences, and mass loss when removing the end caps for visual inspection. Visual defects were noted by Applicant. Crystallization appears as an opaque region when observed at an oblique angle relative to a light source. All coatings were noted as continuous with no observable coverage gaps. Flaking, or coating delamination, was not observed even after a 15 minute, 400 liter per minute flow test. Film thicknesses were measured with a calibrated Positector 6000 acoustic film measurement device. Three measurements were taken approximately 2 cm from both tube ends. The reported values are averages of the three replicate measurements for each tube end.

Applicant conducted the Storage Stability Test to determine how temperature and time impacted coated tube shelf life.

The initial test hypothesis that crystallization may cause problems due to delamination and fragility were not supported at any time points. Crystallization was evident from the onset of coating deposition and did not significantly worsen over time. Coated tubes did not lose significant mass during air flow tests after being stored for time periods up to, and including, 24 weeks. The last time point indicated water was being absorbed by the films and was possibly due to the dessicant packet reaching saturation. Tubes performed similarly under either storage temperature with humidity being controlled by the packaging configuration (i.e. low water permeability plastic bags and a dessicant package).

Applicant recommends continuing to package coated ESP tubes in vacuum-sealed plastic zip-loc bags with a dessicant packet and humidity indicator card. The packaging will reduce the amount of water the tubes are exposed to and allow chain-of-custody and contamination/tamper seal concerns to be addressed. Applicant concludes that ESP tubes can be used without performance impact for at least 24 weeks when stored between 5-30° C. There were indications that storage durations longer than 16 weeks may cause excessive water absorption that could result in re-liquefying the trehalose coating. Longer storage periods may be possible if additional dessicant packets were inserted into the packaging.

Coating crystallization does not impact coating delamination as initially theorized. Applicant observed crystallization occurring prior to placing the coated tubes within a sealed plastic package. Applicant has determined that the crystallization was caused by using heat to evaporate the water from the coating solution. Heat is not required for coating the tubes but it does reduce the process time for better manufacturability. Applicant has proposed to identify alternative techniques to scale-up coated tube production for a Phase III effort.

The tube coating studies have revealed three (3) main characteristics that one should look for in potential coatings, namely:

1. Compatibility with the intended collection target;

2. Water solubility—enable simple extraction off of the ESP tube;

3. Surface wetting—the coating must wet the tube evenly to enable a thin uniform thickness coating.

The thin uniform coating is necessary to ensure proper collection performance and that the coating can be rinsed with a minimal volume of water. One can tweak the wettability by changing tube materials if necessary (note: wetting properties are based on the combination of the coating and the tube material). In general, many different sugar based coatings will work well. Illustrative saccharides include, but are not limited to, glucose, fructose, galatose, ribose, trehalose, sucrose, lactose, maltose, cellobiose, raffinose, hydrophilic polysaccharides, and mixtures thereof. Trehalose works particularly well in the present coating solution. Gelatin based coatings have also been used successfully in the past as well.

### Improved FASST Mk III Design

The improved FASST MK III collector is substantially similar to the FASST MK III collector 46 described in detail above except that it includes two additional features, namely, an automatic altitude adjustment feature and an electrostatic discharge feature. In all other respects, the construction and operation of the improved MK III collector will be substantially identical to the components, features and operation of the MK III collector 46 discussed above and illustrated in FIGS. 29-50.

### Automatic Altitude Adjustment

The automatic altitude adjustment feature associated with the improved MK III collector is related to automatically adjusting the collection system settings to optimize performance at varying altitudes. The electrostatic method employed by the present FASST system relies on a corona discharge to ionize the air stream and ultimately charge and collect the incoming particulates. The actual corona onset voltage produced by the high voltage supply assembly 84 is a function of many environmental variables such as temperature, humidity, air pressure, as well as geometric variables such as the radius of the electrode wire 64. The improved MK III collector automatically adjusts the electrode voltage based on atmospheric pressure measurements from an onboard pressure sensor. This feature is important since the corona onset voltage can vary by several thousand volts depending upon whether the system is used at sea level or in mountainous regions. Omission of the altitude feedback mechanism could result in either excessive arcing and electrical power draw at high altitudes or reduced collection efficient at lower altitudes.

The required voltage supplied to the wire electrode 64 in order to generate corona discharge to ionize the incoming air stream will decrease as altitude increases. In the present configuration, a pressure sensor is utilized to read atmospheric pressure. The pressure sensor is presently located on the main PC board 86 (FIG. 31) but such sensor could be located anywhere on the device so long as it is exposed to atmospheric pressure. The pressure sensor reads the pressure and then the altitude adjustment circuitry associated with the main PC board 86 uses a look-up table stored in memory to adjust the electrode voltage based on the measured atmospheric pressure. The look-up table converts the atmospheric pressure to an altitude and then associates a predetermined voltage with such altitude. An altitude range and high voltage adjustment table such as Table 11 set forth below correlates specific altitude ranges with a specific high voltage. Depending upon the specific altitude at which the improved MK III collector is being used, the high voltage power supply 96 will provide the appropriate voltage to the electrode to establish the necessary ionization field.

TABLE 11
Altitude Range and High Voltage Adjustment Table

| Altitude Range | Voltage |
|---|---|
| (feet above sea level) | (volts) |
| 0-9,999 | 10,000 |
| 10,000-11,249 | 9,500 |
| 11,250-12,449 | 9,000 |
| 12,450-13,749 | 8,500 |
| 13,750-15,000 | 8,000 |

This automatic altitude adjustment feature can be incorporated into any of the other embodiments of the FASST collector including the MK II collector illustrated in FIGS. 8-12 as well as the MK III collector 46 illustrated in FIGS. 29-50.

### Electrostatic Charge Dissipation

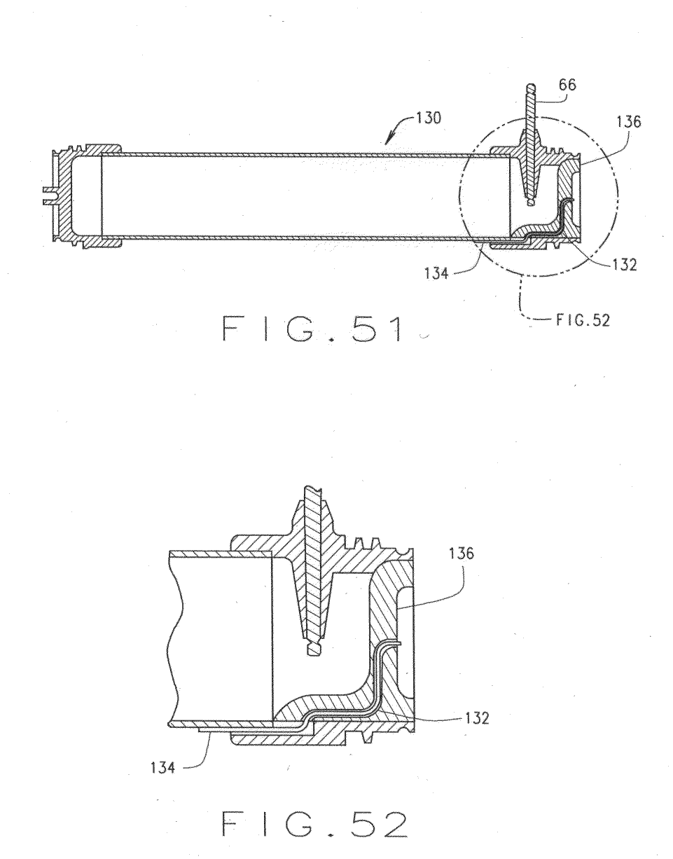

FIGS. 51 and 52 are cross-sectional views of the collection tube module 130 of the improved MK III collector which includes a bundle of fine-tipped electrical conductors 132 which functions as a static discharge wire similar to that use on aircraft. Transition from a FASST system that uses alternating current power from grounded electrical outlets to a battery powered system such as the MK III collector system requires modifications to prevent excessive electrostatic charge build-up during use. A static discharging element 130 is introduced into the collection tube itself as illustrated in FIGS. 51 and 52. This technology is based on the static dischargers commonly used on aircraft. In the aircraft application, electrostatic charge builds on the aircraft during flight primarily due to triboelectric effects as the aircraft flies through the air. Aircraft typically use static dischargers on the trailing edges of the wing and fuselage to bleed excess charge off of the aircraft and back to the airstream. Without these static dischargers, the excess charge on an aircraft could lead to electrical noise that interferes with aircraft communication systems.

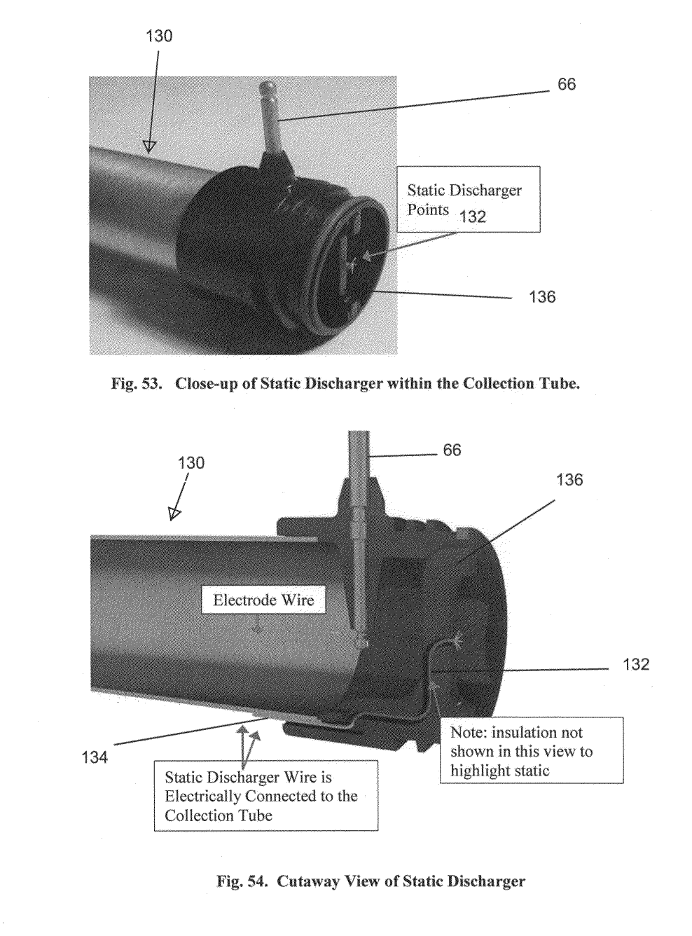

The improved MK III collection tube 130 includes a bundle of fine-tipped electrical conductors 132 inside the collection tube 130 to perform a similar function. The conductors 132 are electrically connected to the collection tube at point 134 and a holder member 136 to hold the opposite end of the static discharge wire 132 is positioned at the center of the rear portion of the tube as illustrated in FIGS. 51 and 52. This technique aids in the dissipation of excess charge which may accumulate on the collection tube and bleeds off this excess charge back into the airstream entering the dry filter 14 and vacuum hose 12. Without the static discharge wire 132 placed inside the collection tube module 130, a battery powered system collecting large amounts of dry dust in low humidity conditions may build up enough of a charge to shock the user within seconds of operation. FIG. 53 is a perspective view of one end portion of the static discharge wire 132 held in its proper position by holder member 136 and FIG. 54 is a cross-sectional view of FIG. 53 showing one end portion of the static discharge wire electrically connected to the collection tube at point 134 and its opposite end portion held in proper position by holder member 136. The static discharge wire 132 is illustrated in FIG. 54 without any surrounding insulation so as to highlight the bundle of fine-tipped connectors associated with the discharge end portion. This arrangement of a bundle of fine-tipped connectors at the discharge end portion aids in the dissipation of excess charge which may collect on the collection tube module 130.

It is recognized and anticipated that the electrical discharge wire 132 and holder 136 can be utilized and incorporated into the other embodiments of the present FASST collector including the MK II collector.

Thus there has been shown and described several embodiments of a FASST collector system and construction which provides improved ability to compartmentalize small particles within the size of biological organisms for rapid recovery from a collection vessel, which constructions fulfill all of the objects and advantages sought therefor. Many changes, modifications, variations and other uses and applications of the present invention will, however, become apparent to those skilled in the art after considering this specification and the accompanying drawings. All such changes, modifications, variations and other uses and applications which do not depart from the spirit and scope of the invention are deemed to be covered by the invention as described herein.

1. A particle collector for collecting biological material comprising:
a removable collection tube assembly having an outer tube, an inner electrostatic precipitator (ESP) tube and an electrode wire suspended within the inner ESP tube;
a power connection for providing power to the collector;
a high voltage power supply coupled to said electrode wire for generating an ionization field within said inner ESP tube, said ionization field causing smaller particles entering the particle collector to precipitate onto the walls of the inner ESP tube;
electronics including a microprocessor for controlling the operation of the particle collector; and
a housing assembly for housing said collector tube assembly and said electronics.

2. The particle collector defined in claim 1 including an inertial separator positioned in front of said inner ESP tube, said inertial separator directing larger particles entering said particle collector around said inner ESP tube for passage through said outer tube.

3. The particle collector defined in claim 1 wherein the walls of said inner ESP tube are coated with a trehalose/betaine aqueous solution.

4. The particle collector defined in claim 3 wherein said inner ESP tube is made of aluminum.

5. The particle collector defined in claim 1 including a filter adapter coupled to one end portion of said particle collector.

6. The particle collector defined in claim 5 including a filter coupled to said filter adapter downstream from said inner ESP tube.

7. The particle collector defined in claim 6 including a vacuum system coupled to said filter.

8. The particle collector defined in claim 1 including an intake nozzle coupled to one end portion of said particle collector.

9. A particle collector for collecting biological material comprising:
a removable electrostatic precipitator (ESP) collection tube having an electrode wire suspended therein;
a power connection for providing power to the particle collector for operating the same;
a high voltage power supply coupled to said electrode wire for generating an ionization field within said collection tube causing smaller particles entering said collection tube to precipitate onto the walls of said collection tube;
electronics including a microprocessor for controlling the operation of the particle collector; and
a housing for holding the collection tube, the electronics and the high voltage power supply, said housing including an access door for providing access to and removal of said collection tube from said housing.

10. The particle collector defined in claim 9 including an interlock mechanism for enabling high voltage to said electrode wire, said interlock mechanism including at least one sensor system positioned and located for sensing when the collection tube is properly positioned within said housing, said sensor system preventing high voltage to said electrode wire if said collection tube is not properly positioned within said housing.

11. The particle collector defined in claim 10 wherein said at least one sensor system is a Hall Effect sensor system.

12. The particle collector defined in claim 10 including an interlock mechanism enabling high voltage to said electrode wire, said interlock mechanism including at least one sensor system positioned and located for sensing when the access door is properly closed, said sensor system preventing high voltage to said electrode wire if said access door is not properly closed.

13. The interlock mechanism defined in claim 12 wherein said at least one sensor system is a Hall Effect sensor system.

14. The particle collector defined in claim 10 wherein said at least one sensor system disables high voltage to said electrode wire if said collection tube becomes dislodged or is not properly installed within said housing.

15. The particle collector defined in claim 12 wherein said at least one sensor system disables high voltage to said electrode wire if said access door becomes dislodged or is not properly closed.

16. The particle collector defined in claim 9 wherein said electronics includes a current sensor which monitors the high voltage power supply for excessive current draw and communicates with said microprocessor to disable the high voltage to said electrode wire if excess current draw occurs.

17. The particle collector defined in claim 9 wherein said electronics includes a voltage sensor which monitors the high voltage power supply for under voltage and communicates with said microprocessor to disable the high voltage to said electrode wire if an under voltage occurs.

18. The particle collector defined in claim 9 wherein said electronics includes a temperature sensor which monitors the high voltage power supply for excessive temperature and communicates with said microprocessor to disable the high voltage to said electrode wire if excessive temperature occurs.

19. The particle collector defined in claim 1 including an on/off switch for activating high voltage to said electrode wire.

20. The particle collector defined in claim 9 including a filter adapter coupled to one end of said collection tube.

21. The particle collector defined in claim 20 including a filter coupled to said filter adapter downstream from said collection tube.

22. The particle collector defined in claim 21 including a vacuum system coupled to said filter.

23. The particle collector defined in claim 22 including a vacuum choke positioned between said vacuum system and said filter for reducing the flow of air through the particle collector to a predetermined flow rate.

24. The particle collector defined in claim 23 wherein said flow rate is 400 L/min.

25. The particle collector defined in claim 9 including a pair of sealing end caps for positioning over the respective end portions of said collection tube when the collection tube is removed from said housing.

26. The particle collector defined in claim 9 including a high voltage light which illuminates when high voltage is being supplied to said electrode wire.

27. The particle collector defined in claim 10 including an interlock light which illuminates when said at least one sensor system senses that the particle collector is ready for high voltage to be enabled.

28. The particle collector defined in claim 9 wherein the ESP collection tube is coated with a trehalose/betaine aqueous solution.

29. The particle collector defined in claim 9 including an intake nozzle coupled to one end of said ESP collection tube.

30. The particle collector defined in claim 29 wherein said intake nozzle includes a filter.

31. The particle collector defined in claim 9 including an electrostatic discharge mechanism associated with said collection tube for dissipating excessive electrostatic charge which may accumulate on said collection tube during operation.

32. The particle collector defined in claim 9 including an altitude adjustment mechanism for adjusting the amount of high voltage supplied to said electrode wire based upon the altitude at which the particle collector is being used.

33. A portable particle collector for collecting biological material comprising:
a removable electrostatic precipitator (ESP) collection tube having an electrode wire suspended therein;
a high voltage power supply coupled to said electrode wire for generating an ionization field within said collection tube causing smaller particles entering the collection tube to precipitate onto the walls of said collection tube;
electronics including a microprocessor for controlling the operation of the particle collector;
a housing assembly for housing said collection tube, the high voltage power supply and the electronics for controlling the operation of the particle collector, said housing including an access door for accessing and removing the collection tube from said housing assembly;
a handle assembly for grasping and carrying the particle collector;
at least one battery for powering the particle collector including the high voltage power supply; and
a user interface for allowing a user to control the operation of said particle collector.

34. The particle collector defined in claim 33 wherein said at least one battery is housed within said handle assembly.

35. The particle collector defined in claim 33 wherein said user interface includes an on/off button for supplying power from said at least one battery to the particle collector.

36. The particle collector defined in claim 33 wherein said user interface includes a plurality of battery life status indicators for determining the available battery life.

37. The particle collector defined in claim 33 wherein said user interface includes an on/off collection button for enabling and disabling high voltage to said electrode wire.

38. The particle collector defined in claim 33 wherein said user interface includes at least one operational status indicator.

39. The particle collector defined in claim 38 wherein said at least one operational status indicator includes a collection status light which will remain on as long as high voltage is being supplied to said electrode wire.

40. The particle collector defined in claim 38 wherein said at least one operational status indicator includes a safety error light which will illuminate in a specific predetermined pattern if the access door is not closed.

41. The particle collector defined in claim 38 wherein said at least one operational status indicator includes a safety error light which will illuminate in a specific predetermined pattern if the collection tube is not properly installed within said housing assembly.

42. The particle collector defined in claim 38 wherein electronics includes a current sensor for monitoring excessive current draw from said high voltage power supply, a voltage sensor for monitoring under voltage from said high voltage power supply, and a temperature sensor for monitoring excessive temperature from said high voltage power supply, and wherein said at least one operational status indicator includes a high voltage error light which illuminates in a specific predetermined pattern if one of said sensors monitors excessive current draw, under voltage, or excessive temperature from the high voltage power supply.

43. The particle collector defined in claim 33 wherein said ESP collection tube is made of an aluminum alloy.

44. The particle collector defined in claim 33 wherein said ESP collection tube is coated with a trehalose/betaine aqueous solution.

45. The particle collector defined in claim 33 including an intake nozzle cooperatively attachable to the front portion of said collection tube.

46. The particle collector defined in claim 45 wherein said intake nozzle includes a front end screen which functions as a filter to eliminate large material from entering the collection tube.

47. The particle collector defined in claim 45 including an interlock system for enabling high voltage to said electrode wire, said interlock system including a sensor for sensing the position of said intake nozzle within said housing assembly to ensure proper positioning of said collection tube within said housing assembly, said interlock system preventing high voltage to said electrode wire if the front portion of said collection tube is not properly installed within said housing assembly.

48. The particle collector defined in claim 33 including a filter adapter cooperatively attachable to the rear portion of said collection tube.

49. The particle collector defined in claim 48 wherein said filter adapter includes a pair of magnet latches which mate with a corresponding pair of magnet latches associated with said access door for latching said access door to said filter adapter.

50. The particle collector defined in claim 48 including an interlock system for enabling high voltage to said electrode wire, said interlock system including a sensor for sensing the position of said filter adapter within said housing assembly to ensure proper positioning of said collection tube within said housing assembly, said interlock system preventing high voltage to said electrode wire if the rear portion of said collection tube is not properly installed within said housing assembly.

51. The particle collector defined in claim 33 including an interlock system for enabling high voltage to said electrode wire, said interlock system including a sensor for sensing the position of said access door within said housing assembly to ensure that the access door is properly closed, said interlock system preventing high voltage to said electrode wire if said access door is not properly closed.

52. The particle collector defined in claim 33 including an interlock system for enabling high voltage to said electrode wire, said collection tube including a filter adapter cooperatively attachable to one end portion thereof and an intake nozzle cooperatively attachable to its opposite end portion, said interlock system including a first sensor for sensing the proper position of said intake nozzle within said housing assembly, a second sensor for sensing the proper position of said filter adapter within said housing assembly, and a third sensor for sensing the proper position of said access door within said housing assembly, said interlock system preventing high voltage to said electrode wire if any one of said first, second and third interlock sensors does not sense the proper position of said intake nozzle, filter adapter, or access door within the housing assembly.

53. The particle collector defined in claim 33 including a pair of end caps for positioning over the respective end portions of said collection tube when said collection tube is removed from said housing assembly, at least one of said end caps having at least one injection/extraction port associated therewith for both injecting a solution into said collection tube to help preserve the biological material collected therein and for extracting the biological material from said collection tube.

54. The particle collector defined in claim 33 including an altitude adjustment mechanism for adjusting the amount of high voltage supplied to said electrode wire based upon the altitude at which the particle collector is being used.

55. The particle collector defined in claim 54 wherein said altitude adjustment mechanism includes a sensor positioned and located to read atmospheric pressure, said microprocessor coupled to said sensor and converting the atmospheric pressure sensed by said sensor to an altitude, said microprocessor further selecting a pre-determined high voltage level based upon the altitude reading and communicating with said high voltage power supply to provide a pre-determined voltage to said electrode wire when said high voltage is enabled.

56. The particle collector defined in claim 33 including an electrostatic discharge mechanism for dissipating excessive electrostatic charge which may accumulate on the collection tube during operation.

57. The particle collector defined in claim 56 wherein said electrostatic discharge mechanism includes a static discharge element positioned within said collection tube, said discharge element having one end portion connected to said collection tube and having its opposite end portion positioned and located at the rear portion of said collection tube.

58. The particle collector defined in claim 57 wherein the static discharge element includes a bundle of fine-tipped electrical conductors.

59. The particle collector defined in claim 58 wherein one end portion of the fine-tipped electrical conductors is positioned and located at the center of the rear portion of said collection tube.

60. The particle collector defined in claim 9 wherein the ESP collection tube is coated with a sugar based aqueous solution.

61. The particle collector defined in claim 33 wherein the ESP collection tube is coated with a sugar based aqueous solution.
